(19) United States
(12) Patent Application Publication
(10) Pub. No.: US 2009/0180880 A1
(43) Pub. Date: Jul. 16, 2009

(54) CHECK VALVE TURBINE

(76) Inventor: Seyhan ERSOY, Bethlehem, PA (US)

Correspondence Address: ARENT FOX LLP, 1050 CONNECTICUT AVENUE, N.W., SUITE 400, WASHINGTON, DC, 20036, US

(21) Appl. No.: 12/331,947

(22) Filed: Dec. 10, 2008

Related U.S. Application Data
(60) Provisional application No. 61/020,860, filed on Jan. 14, 2008.

(51) Int. Cl. F03D 3/06

(52) U.S. Cl. 416/132 R

(57) ABSTRACT

A check valve turbine assembly includes an assembly base, a vertical member rotatable relative to the base, and a sail assembly attached to the vertical member, wherein the sail assembly has a frame with parallel horizontal airfoil members and parallel vertical airfoil members, a sub frame connected to the horizontal and vertical airfoil members, and a plurality of flaps rotatably attached to the sub frame. In another aspect of the disclosure a turbine assembly includes an assembly base, a vertical member rotatable relative to the base, and at least one flexible sail assembly attached to the vertical member. In another aspect of the disclosure, a turbine system includes a a floating platform, a generator, a gearbox connected to the generator; and a check valve turbine assembly that drives the gearbox. Another aspect of the disclosure includes a check valve assembly with a longitudinal center section and a wing section.

### CROSS-REFERENCE TO RELATED APPLICATION

This application claims priority from U.S. Provisional Application No. 61/020,860 filed Jan. 14, 2008, the entirety of which is hereby incorporated by reference herein.

### BACKGROUND OF THE INVENTION

Civilization relies upon electricity to meet society's needs and major sources of electrical power are coal, hydroelectricity, and nuclear energy.

Although coal is abundant and is predicted to supply electricity for the next 300 years, coal is a major source of CO₂ in the atmosphere. The presence of high levels of CO₂ in the atmosphere is widely believed to create what is commonly known as the greenhouse effect, which is reported to be a major source of global warming. Humans are known to produce CO₂ through coal burning power plants and automobiles and other vehicles that are powered by internal combustion engines at a rate that is much faster than the environment can absorb the CO₂ emissions. The relatively high levels of CO₂ in the earth's oceans are believed to increase the acidity levels of the ocean's water, which in turn adversely effects marine life. Coal is also the source of sulfur, which causes acid rain that detrimentally affects oxygen producing vegetation.

Nuclear power plants do not produce the same negative affects as coal. However, nuclear power plants are viewed with scorn by many people in society as they are the source of nuclear waste which presents difficult choices in terms of determining suitable locations for disposal.

Hydroelectric power, on the other hand, is one of the most favorable sources for producing electricity. However, hydroelectric power plants are extremely expensive to construct and pose their own problems to the environment. Moreover, even though most developed countries have reached maximum capacity for producing hydroelectric power, the demand for electricity in the countries continues to rise at a steady rate.

In view of the above, there is a need for clean, environmental friendly, and renewable electric power sources, such as, for example, solar, wind and geothermal power. While some regions of the planet include vast sources of geothermal power, many regions of the planet are not as fortunate. Although solar and wind power sources suffer from the problem of being intermittent in nature, recent advancements in technologies have made wind and solar energy an attractive and economically feasible solution to fulfill the deficiency in electricity power sources.

It is with the above issues in mind, wherein the present invention relates to wind turbines and, in particular, to wind turbines having a vertical axis.

For centuries, wind power has been a source of energy and has been harnessed in various fashions. There is a clear distinction between the manner in which wind energy is harnessed. In particular, there are horizontal axis wind turbines (HAWTs) and vertical axis wind turbines (VAWTs).

In modern times, the prevalent methodology for harnessing wind energy has been to use a HAWT, which typically has used three airfoil sails. While HAWT's have been promoted as being the more efficient relative to VAWTs, HAWTs present several disadvantages. For example, HAWT's are mono-directional, which means they have to be turned into the wind. Also, the minimum operational wind speed (cut-in speed) of HAWTs is relatively high and the maximum wind speed (cut-out speed) that can be endured is relatively low, allowing for only a relatively narrow window of operation, beyond which they are prone to damage and have to stop operating. Furthermore, the serviceable components of HAWTs usually sit high up in the so-called nacelle, on top of a tall pillar, which is rather inconvenient for servicing and replacement of parts. Moreover, although HAWTs are considered “fast-runners” based on their lift factor, the actual slewing speed of HAWTs is relatively low (typically in the range of 15 to 30 RPM), which necessitates expensive multi-stage gearboxes and negatively impacts the overall system efficiency and costs. Further, the overall design of HAWTs does not facilitate or make practical “do-it-yourself construction.”

Currently, the commercial application of wind energy harnessing techniques is primarily, if not, exclusively, HAWT focused even though VAWTs avoid most of the above disadvantages inherent in HAWTs. For example, and by no means limiting, VAWTs are omni-directional and have a lower cut-in wind speed and higher cutout speed, thus making the window of operation wider. Also, VAWTs have serviceable components that can be concentrated or located at a bottom end of the structure, thereby providing easy accessibility. VAWTs are considered “low runners” as a result of their low lift factor, and, because VAWTs actually slew faster compared to HAWTs, VAWTs allow for smaller-ratio gearboxes, which are less expensive and more efficient than the gear boxes needed to operate HAWTs. VAWTs also are able to operate at higher wind speeds and at a lower risk of suffering wind damage. Additionally, VAWTs lend themselves to simple design and construction.

Two main types of VAWTs are described below, that is, lift based (pull type) and drag based (push type).

### Lift Based (Pull Type) VAWTs

One of the more popular lift based or pull type VAWTs is the Darrieus Wind Turbine (see FIG. 1), which is characterized by C-shaped rotor sails, which appear similar to modern day eggbeaters. The Darrieus Wind Turbine normally includes two or three sails and was patented in 1931 by a French aeronautical engineer named Georges Jean Marie Darrieus.

In the original versions of the Darrieus design, the aerofoils were arranged symmetrically with no (i.e., zero) rigging angles. That is, the aerofoils are set at an angle relative to the structure on which they are mounted. This arrangement is equally effective regardless of the direction the wind is blowing, which is in contrast to the conventional arrangement needed to face the wind to rotate.

As shown in FIGS. 2A and 2B, when the Darrieus rotor is spinning, the aerofoils move forward through the air in a circular path. Relative to the sail, the oncoming airflow is added vectorially to the wind, so that the resultant airflow creates a varying small positive angle of attack (AoA) to the sail and generates a net force pointing obliquely in a forward direction along a “line-of-action.” The net force is projected inwards past the turbine axis at a given distance, providing a positive torque to the shaft, thereby helping the shaft rotate in the direction it is already traveling. The aerodynamics rotating the rotor is equivalent to autogiros and normal helicopters in autorotation.

As the aerofoil moves around the back of the apparatus, the angle of attack changes to the opposite sign, but the generated force is still oblique relative to the direction of rotation because the wings are symmetrical and the rigging angle is still zero. Accordingly, the rotor spins at a rate unrelated to the wind speed and usually many times faster than the wind speed. The energy arising from the torque and speed may be extracted and converted into useful power by using an electrical generator.

The aeronautical terms lift and drag are, strictly speaking, forces across and along the approaching sail relative to the airflow, so they are not useful here. What is important to determine is the tangential force pulling the sail around and the radial force acting against the bearings of the assembly.

When the rotor is stationary, no net rotational force arises, even if the wind speed increases relatively high as the rotor is already spinning to generate torque. Thus, the design is normally not self-starting. It should be noted though, that under extremely rare conditions, Darrieus rotors can self-start, so some form of braking is required to hold the rotor when stopped.

One problem with the design is that the angle of attack changes as the turbine spins, so each sail generates its maximum torque at two points on its cycle (front and back of the turbine). This leads to a sinusoidal (pulsing) power cycle that complicates the overall design. In particular, almost all Darrieus turbines have resonant modes where, at a particular rotational speed, the pulsing power cycle coincides with a natural frequency of the sails that can cause the sails to break. For this reason, most Darrieus turbines have mechanical brakes or other speed control devices to keep the turbine from spinning at such speeds for a lengthy period of time.

Another problem with the design arises due to the mass of the rotating mechanisms being at the periphery rather than at the hub, as with a propeller. The design creates very high centrifugal stress levels on the mechanism, which must be stronger and heavier than otherwise would be needed just to withstand the force. One common approach to minimize the force is to curve the wings into an “egg-beater” shape (this is called a “troposkein” shape, derived from the Greek for “the shape of a spun rope”) such that they become self supporting and do not require such heavy supports and mountings.

In this configuration, the Darrieus design is theoretically less expensive than a conventional design as most of the stress is in the sails which torque against the generator located at the bottom of the turbine. The only forces that need to be vertically balanced are the compression load that is created by the sails flexing outward (thus attempting to “squeeze” the tower), and the wind force, which may knock the turbine over, half of which is transmitted to the bottom of the turbine and the other half of which is easily offset by using guy wires.

By contrast, a conventional design has the entire wind force attempting to push the tower over at the top, which is where the main bearing is located. Additionally, guy wires are not easily used to offset the load because the propeller spins both above and below the top of the tower. Thus, the conventional design requires a strong tower that grows exponentially with the size of the propeller. Modern designs can compensate most tower loads of that variable speed and variable pitch.

Overall, while there are some advantages in the aforementioned Darrieus design, there are many more disadvantages, especially with bigger machines in the MW class. Also, the Darrieus design uses more expensive materials for the sails while most of the sail is too close to the ground to provide enough power. Traditional designs assume that wing tip is at least 40 m from ground at the lowest point to maximize energy production and life time. So far, there is no known material (including carbon fiber) which can meet cyclic load requirements of the Darrieus design.

While in theory the Darrieus design is as efficient as the propeller type design if the wind speed is constant, in practice such efficiency is rarely realized due to the physical stresses and limitations imposed by the practical design and wind speed variations. There are also substantial difficulties in protecting the Darrieus turbine from extreme wind conditions and in making it a self-starting assembly.

Darrieus' 1927 patent also disclosed several embodiments that used vertically arranged airfoils. See FIG. 3. One of the more common vertical airfoils is the Giromill or H-bar design shown in FIG. 4 wherein the long “egg beater” sails of the common Darrieus design are replaced with straight vertical sail sections attached to the central tower via horizontal supports. The Giromill sail design is much simpler to build, but puts more weight into the structure as opposed to sails, which means that the sails themselves have to be stronger.

Another variation of the Giromill is the Cycloturbine, which has sails that are mounted such that the sails can rotate around their vertical axis. The design of the Cycloturbine allows the sails to be “pitched” such that the sails are always at an angle relative to the wind. The main advantage to this design is the torque generated remains almost constant over a fairly wide angle. Therefore, a Cycloturbine with three or four sails has a fairly constant torque. Over a predetermined range of angles, the torque approaches the possible maximum torque, wherein the system generates more power. The Cycloturbine also has the advantage of being able to self start by pitching the “downwind moving” sail flat to the wind to generate drag and start the turbine spinning at a low speed. One drawback to this design is that the sail pitching mechanism is complex and generally heavy, and a wind-direction sensor must be added to the design in order to properly pitch the sails.

The sails of the Darrieus turbine can be canted into a helix, e.g. three sails and a helical twist of 60 degrees, similar to Gorlov's water turbines, as shown in FIG. 5. Since the wind pulls each sail around on both the windward and leeward sides of the turbine, this feature spreads the torque evenly over the entire revolution, thus preventing destructive pulsations. Moreover, the skewed leading edges reduce resistance to rotation by providing a second turbine above the first, and having oppositely directed helices, the axial wind-forces cancel, thereby minimizing wear on the shaft bearings. Another advantage of the helical design is that the sails generate good torque from upward-slanting airflows, which typically occurs above roofs and cliffs. The helical design is used by the Turby and Quiet Revolution brand of wind turbines.

### Drag Based (Push Type) VAWTs

The Savonius wind turbine, which is shown in FIG. 6, was invented by a Finnish engineer named S. J. Savonius. The Savonius design is an example of the drag based (push type) VAWT. The Savonius turbine can be made with different types of scoops (e.g. buckets, paddles, sail or oil drums.). For example, if one were to view the rotor of a two scoop machine from a bird's eye view, the scoops would create a cross section that would appear to have and “S” shape. While rather low in efficiency but high in torque, the Savonius turbine is used mainly for weed grinding and water pumping applications.

FIG. 7 illustrates a direction adjusting sail type design of a drag based wind turbine. The turbine in this design uses a sail like structure for sails, wherein when the sail is moving in the downwind direction, each sail exposes the entire surface of the sail to the wind. However, when moving in the upwind direction, each sail shows a minimum surface area to the wind. The structure of this design requires a complex adjusting mechanism, wherein the reaction time to any such adjustment is rather slow due to the size of the sails. The sails of this design, which are rather large, are also prone to damage because of their latency to react to the changing wind directions.

A big flap design, which is shown in FIG. 8, is another drag based wind turbine and has a rather simple mechanism that is used to open and close flaps. However, the flap size of the big flap design limits the operation of the turbines and the design does not lend itself to large turbines.

The VAWTS having the highest efficiency that have been described are the Darrieus and Giromills designs. Maintenance issues and sail fatigue which cause premature failure of a system are common problems associated with the Darrieus wind turbine design.

Drag type VAWTs have a substantially low efficiency, which is determined by the ratio between the latent wind energy and the actual power output. One of the main reasons for the inefficiency is half of the sail is moving in the wrong direction, that is, towards the oncoming wind, at any given time. The relative wind speed on the sail moving towards the oncoming wind is higher than the wind speed on the downwind moving sail, wherein the high velocity creates higher drag on the sail moving towards the oncoming wind.

### SUMMARY OF INVENTION

It is an aspect of the invention to provide a Vertical Axis Wind Turbine (hereafter VAWT) which combines the characteristics of lift and drag based wind turbines. The present invention includes a VAWT having a check valve type system provided on at least one sail but will be described herein as being provided on each sail. The check valves close and open while the sails move through the downwind and upwind directions, respectively. It is within the scope of the present invention for the sails and check valves to be built from any type of suitable material and configured in any suitable geometric shape. The present invention is applicable to wind and water turbines, as well as small wing flapping airplanes, such as, for example, only, toys, or very small wing flapping military aircrafts.

### BRIEF DESCRIPTION OF THE DRAWINGS

Various aspects of the present invention are illustrated by way of example, and not by way of limitation, in the accompanying drawings, wherein:

FIG. 1 is a perspective view of a conventional Darrieus-type wind turbine;

FIGS. 2A and 2B are schematic diagrams of a conventional Darrieus-type wind turbine in operation;

FIG. 3 is a perspective view of another conventional Darrieus-type wind turbine with vertically arranged airfoils;

FIG. 4 is a perspective view of a conventional Giromill or H-bar vertical airfoil;

FIG. 5 is a perspective view of another conventional Darrieus turbine with sails canted into a helix;

FIG. 6 is a schematic diagram of a conventional Savonius wind turbine;

FIG. 7 is a diagram of a conventional direction adjusting sail type design of a drag based wind turbine;

FIG. 8 is a diagram of a conventional big flap type design of a drag based wind turbine;

FIG. 9 shows a Vertical Axis Wind Turbine (VAWT) according to an embodiment of the present invention;

FIGS. 10A, 10B and 10C show a front view, a side view and a top view of an exemplary embodiment of the vertical frame members of the VAWT;

FIGS. 11A, 11B and 11C show a top view, a front view and a side view of an exemplary embodiment of the horizontal frame members of the VAWT;

FIG. 12 shows a top view of the sails and operational aspects of the VAWT;

FIGS. 13A and 13B show the flaps in a closed position and in an open position, respectively;

FIGS. 14A and 14B show the flaps in an open position from a top view and a bottom view. FIG. 14C shows a side view of a flap;

FIG. 15 shows the flaps provided in extruded grooves;

FIG. 16 shows a VAWT with rigid sails having a scoop-like structure;

FIGS. 17A and 17B show the front and back of a membrane flap;

FIGS. 17C and 17D show the front and back of a square scoop flap;

FIG. 18 shows a VAWT with sub-sail assemblies;

FIG. 19 is a schematic diagram showing a top view of a sail with sub-sails attached;

FIG. 20 shows a VAWT with rotating sub-sails;

FIG. 21 illustrates an exemplary embodiment of a VAWT with a grid having holes;

FIG. 22 is a top view of a flexible flap attached to a rigid base;

FIG. 23 is a top view of a VAWT with rigid sails having flexible flaps;

FIG. 24 shows a VAWT system used on a sail boat;

FIG. 25 shows a VAWT system where flaps act as a check-valve;

FIG. 26 shows a close up of the flap shown in FIG. 24;

FIG. 27 shows an elastic flap assembly;

FIG. 28 shows an elastic flap assembly wherein the aluminum profile includes extensions;

FIG. 29 shows an exemplary embodiment of a relief mechanism;

FIGS. 30A and 30B are schematic diagrams showing another exemplary embodiment of a relief mechanism;

FIGS. 31A and 31B are schematic diagrams showing yet another exemplary embodiment of a relief mechanism;

FIG. 32 shows a relief mechanism according to another embodiment;

FIG. 33 is a schematic diagram showing a floating power plant with VAWTs;

FIG. 34 illustrates an exemplary embodiment of a pump mechanism for use with a VAWT;

FIG. 35 shows a VAWT with flexible flaps; and

FIG. 36 shows a VAWT system for a flapped wing airplane.

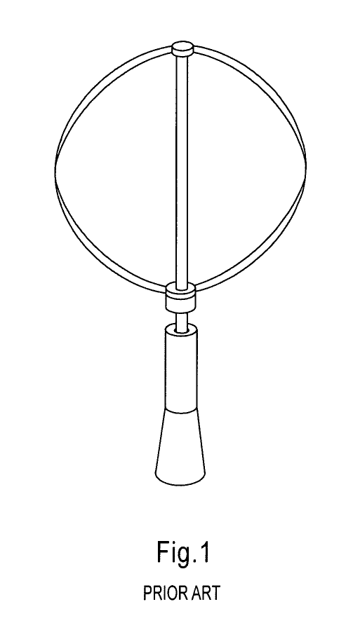

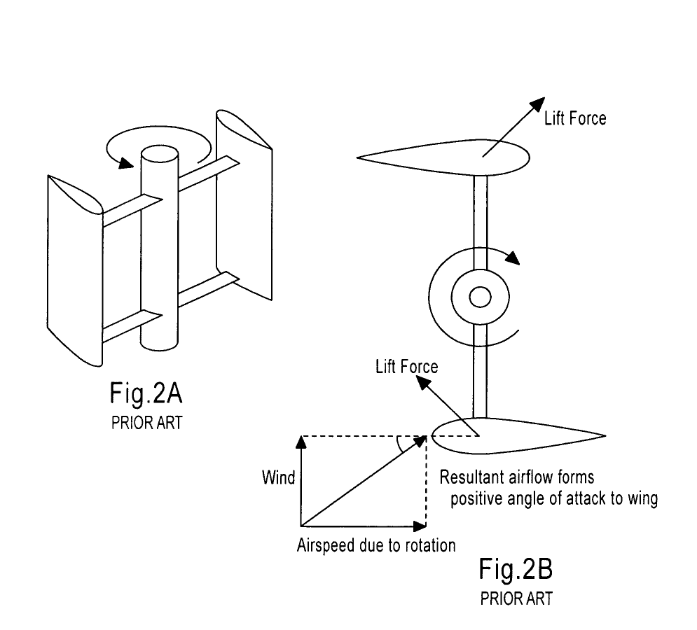

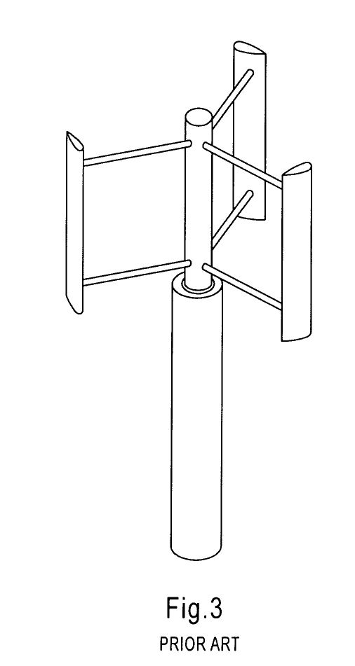

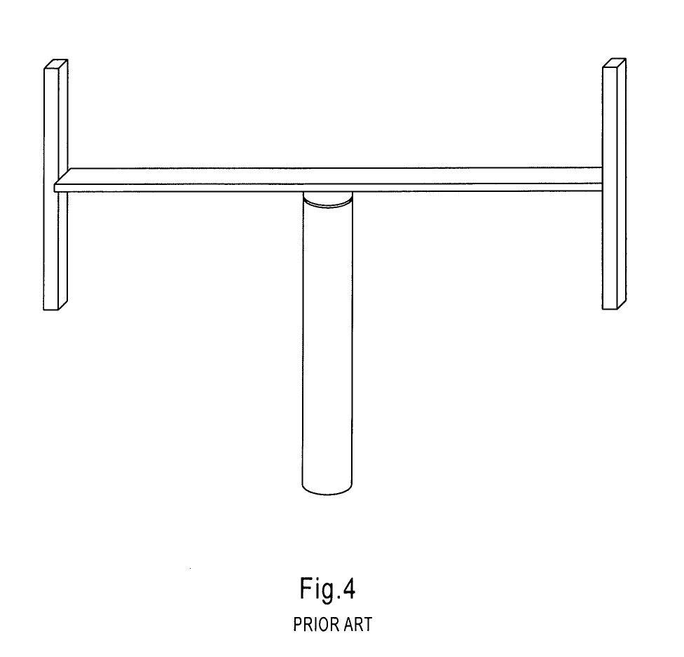

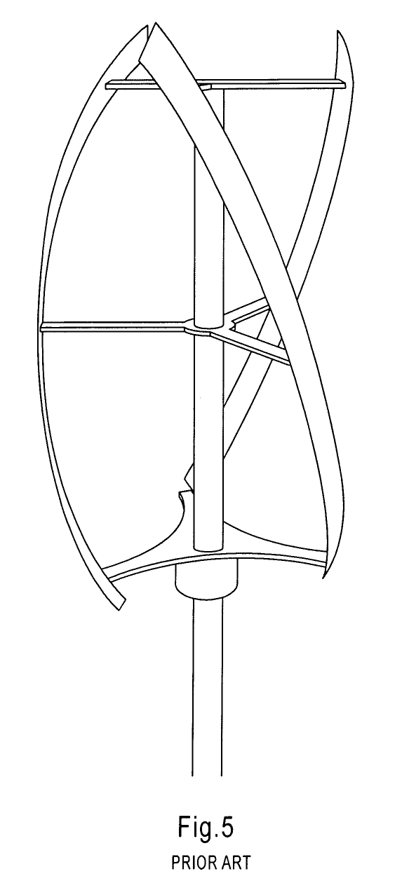

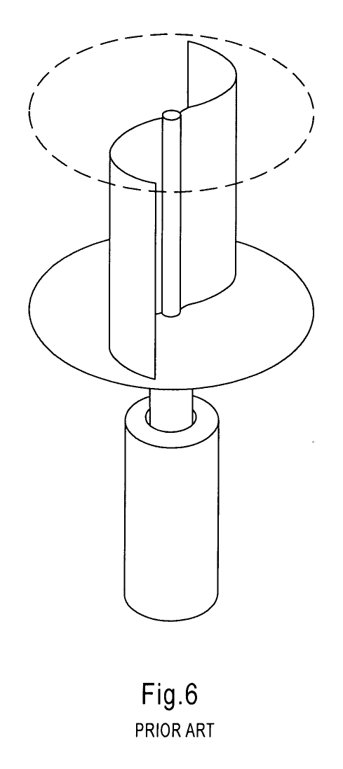

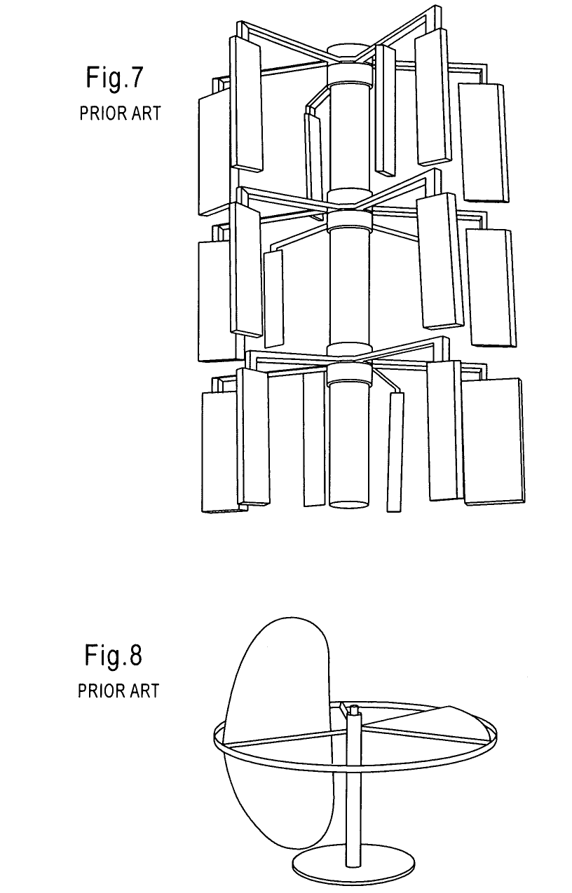

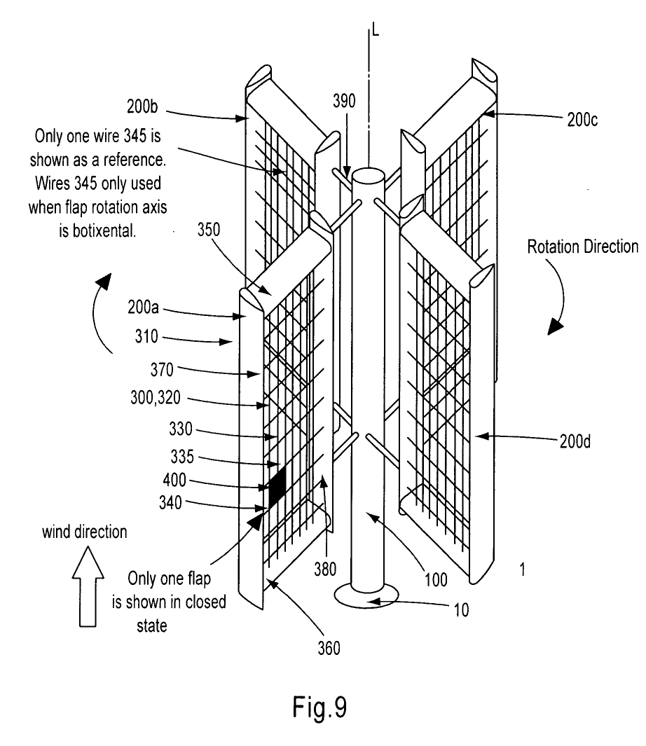

### DETAILED DESCRIPTION OF THE PREFERRED EMBODIMENTS

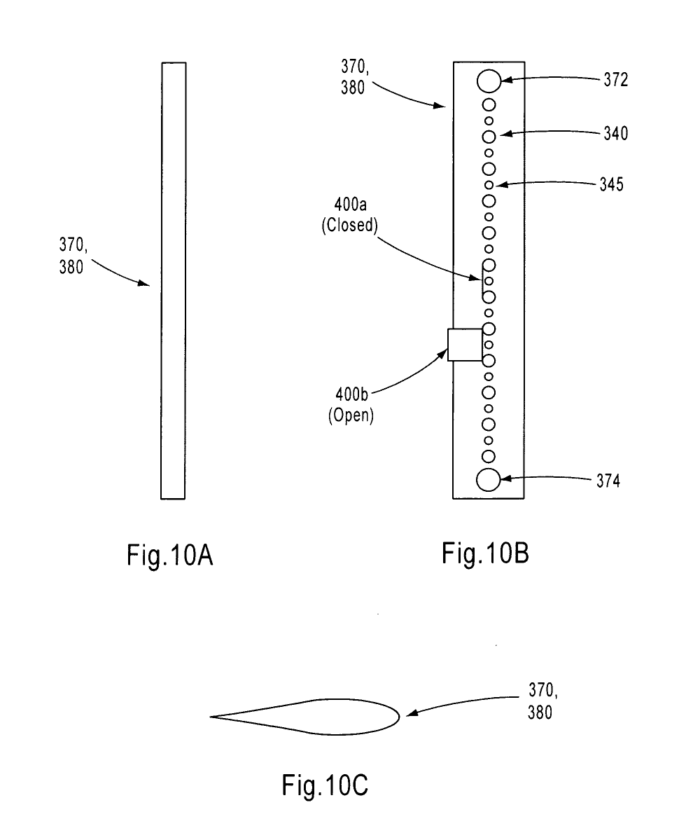

FIG. 9 illustrates an exemplary embodiment of the present invention. The VAWT assembly 1 of the present invention includes an assembly base 10, a vertical member or main shaft 100 coaxial to an axis L of the assembly 1 and a plurality of sails 200a, 200b, 200c and 200d. Although four sails 200a-d are illustrated, it is within the scope of the present invention to include any number of sails ranging from two (2) to n, wherein n is an integer greater than 2 and less than 721, depending on the design and intended use of the VAWT. Because each sail 200a-d is structurally identical to one another, only one sail, 200a will be described herein to avoid redundancy.

The sail 200a has a grid like structure to form a sail base which supports a plurality of moving flaps 400. It is within the scope of the present invention to include any type of suitable grid base that is able to support the moving flaps 400. In FIG. 9, only one flap 400 is shown in a closed state. While not intended to limit the scope of the invention and merely to provide an example of the various designs that are to be considered within the scope of the invention, the grid base can be designed with a wire grid, a flexible net like structure, and the like, and can be made of metal base, a wood base, a polymer base, a plastic base, or a base manufactured form any other known or future developed base having rectangular or any other geometric shaped holes thereon.

To facilitate understanding of the current invention, the description of the sail 200a will be provided hereafter using a sail having wire mesh substructure. The sail 200a includes a grid substructure 300 which has an outer frame 310 and a lattice body structure 320 which is comprised of intersecting vertical members 330 and horizontal members 340. The outer frame 310 includes a top horizontal member 350 and a bottom horizontal member 360 that opposes the top horizontal member 350 and is parallel relative to thereto. The outer frame 310 also includes first side vertical member 370 and a second side vertical member 380 that opposes and is parallel relative to the first side vertical member 370. The first and second side members 350 and 370 are orthogonal relative to the top and bottom horizontal members 350 and 360, respectively. Outer vertical frames 370 and 380 have an airfoil cross section such that these frames act much like the Giromill described before.

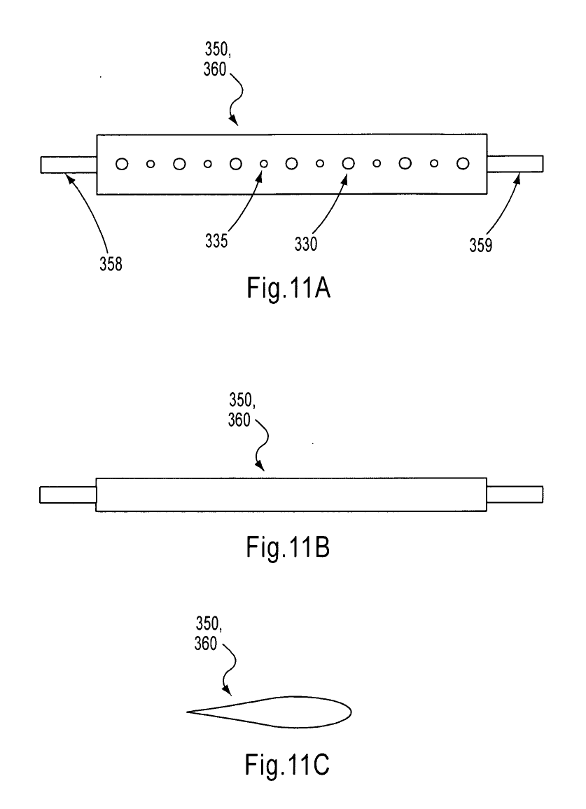

FIGS. 10A, 10B, and 10C show the vertical frame 370 from a front view, side view and a top view, respectively. The upper and lower frames 350 and 360 are connected to the side frames at holes 372 and 374, respectively. The horizontal wires 340 are also shown in FIG. 10B. The smaller wires 345 are the support wires which prevent the flexible flaps 400 from passing through the mesh. It is also within the scope of the present invention for the flaps 400 to be manufactured from rigid material. When the flaps 400 are made from a rigid material, the wires 345 are not needed. The flaps 400 are attached to the grids and cover the grids. In FIG. 10b, one flap 400a is shown in a closed position and another flap 400b is shown in an open position wherein the wire 330 (shown in FIG. 9) serves as a rotation axis of the flaps 400a and 400b. As can be seen in FIG. 10C, the cross section of the vertical frame 370, 380 is like an airfoil.

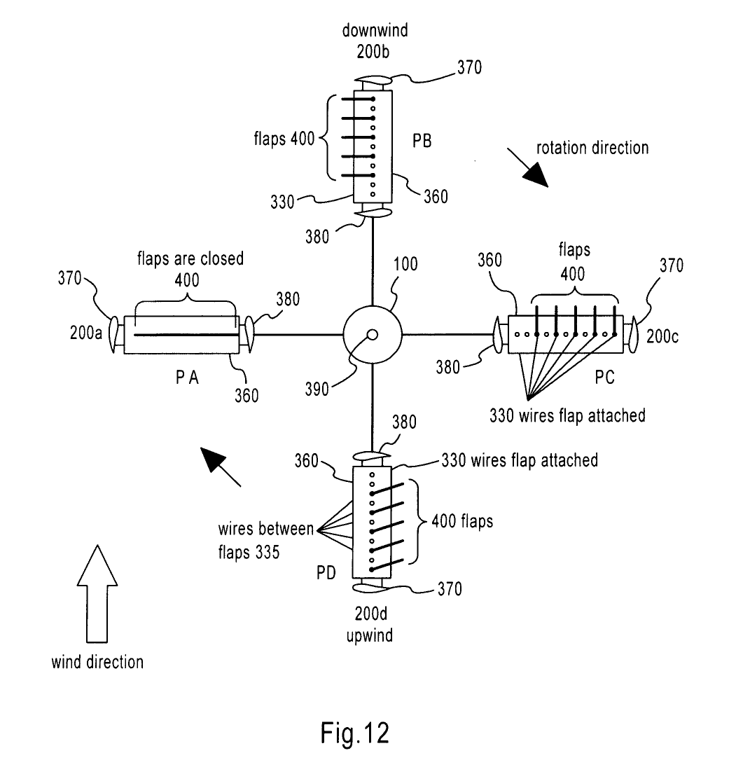

FIGS. 11A, 11B, and 11C show the lower or upper 360 or 350 frame from a top view, front view, and side view, respectively. Extensions 358 and 359 protruding from ends of the frames 350 and 360 are used to join the lower and upper frames 360 and 350 to the side frames 370 and 380. The vertical wires 330 are shown with big circles while the small circles represent wires 335 which will be used as support wires if the flaps 400 are made from flexible material. The flaps 400 are attached to the grid defined by the wires and cover the metal grid. As stated above with respect to the vertical frame, the cross section of the lower and upper frames 360 and 350 is like an airfoil or airplane wing's cross section, wherein during operation of the turbine, lift forces generated by the wind will compensate the weight of the sail 200a so that less force exerted on bearings.

As noted above, the vertical wires 330 or horizontal wires 340 can be the rotation axis of the flaps 400 depending on how the flaps are attached to the grid. For example, if the flaps 400 are arranged on the vertical wires 330, the vertical wires 330 will serve as the rotation axis. However, if the flaps 400 are arranged on the horizontal wires 340, the horizontal wires 340 will serve as the rotation axis of the flaps 400. If the flaps 400 are not made from a rigid material, then support wires 335 (or 345) should be put between the wires 330 (or 340). Depending on the construction of the sail, there may be one or more extra lines or wires extending in the horizontal or vertical direction. The wires 335 or 345 will be thinner than the wires 330 and 340 because they will not have to carry the weight of the flaps 400. The purpose of the wires 335 and 345 is to prevent the flexible flaps 400 from passing through the grid, which would cause the mechanism not to function properly.

The number of the support wires 335 or 345 can be from 1 to n, wherein n is an integer greater than 1 but less than ten (10) million. However the lower the value of n, the less the sail 200a will weigh. It should be noted that there is no need for the support wires 335 and 345 if the flaps are made from a rigid material. In instances where the flaps 400 are manufactured from a solid or non-flexible material, the distance between the parallel wires 330 or 340 will be less than the length of the flaps, which will prevent the flaps 400 from rotating more than 180 degrees, thereby allowing the flaps 400 to stay on one side of the sail. The support wires 335 and 345 are only required for flexible flaps 400 which are able to pass through the rotation wires with the force of the wind during the operation of the turbine. In either case, the flaps 400 may be restricted from full motion by restriction wires 335,345 on the frame 310. While the flaps 400 change from closed to open positions and back, the speed of the action may create noise. By bringing the restriction wires 335,345 closer to the center of rotation of the flaps 400, or placing rotation restrictors (to be described later) on the rotation tube or wire, the noise can be substantially reduced because the speed in which the flaps 400 hit the restriction wires 335,345 is reduced.

The sail 200a has a sub-grid structure wherein the flaps 400 operate as a check valve for the sail 200a. The flaps 400 are arranged in such a manner that during the downwind direction, the flaps 400 are in the closed position, and when in the upwind direction, the flaps 400 are in the open position. It will not be necessary to have a mechanism to open and close the flaps 400, as the open and closed state of the flaps 400 is controlled by their design, how they are arranged, and the direction of the wind.

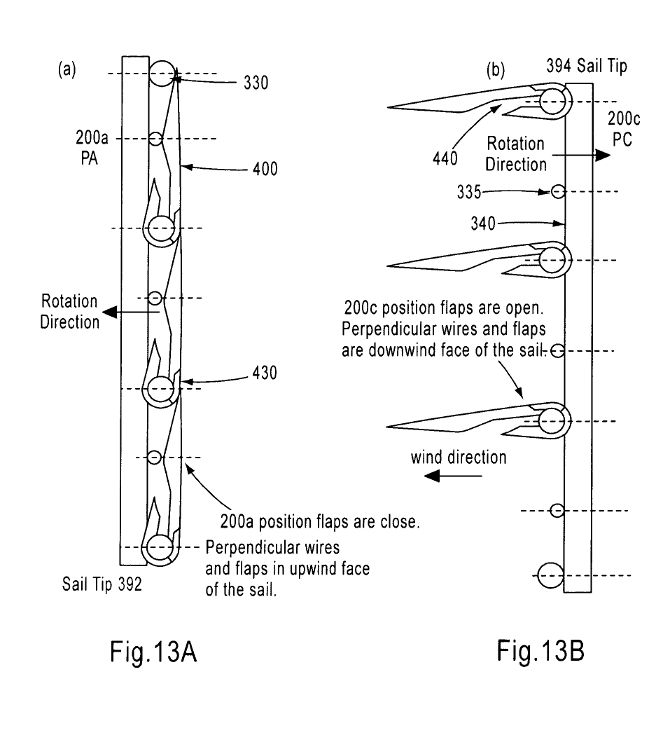

FIG. 12 shows all of the sails 200a-d from a top or plan view of the assembly 1 and can easily determine the direction of the wind and rotation of the assembly 1. Sails 200a and 200c are perpendicular to the wind direction, wherein sail 200a is moving in the downwind direction, and sail 200c is mowing in the upwind direction. On the other hand, sails 200b and 200d are aligned with the wind direction.

To make the description easier to understand, four positions in FIG. 12 are defined wherein the position of the sail 200a is defined as PA (Position A) and the other sail positions are described as PB, PC and PD, respectively.

As shown in FIG. 12, at PA, the flaps 400 are closed and their rotation axis is the wire 330, while the wires 335 (if flaps are flexible or not overlapping) prevent the flaps 400 from going through the holes by the intersecting wires 330 and 335, respectively, even if there is a heavy wind force acting upon them. The flaps 400 are also overlapping one another so that air does not and will not pass between them. The air does not pass between the flaps 400 because the flaps 400 are dimensioned to be longer than a distance between the parallel wires 330. The flaps 400 are attached to the wires 330 where they are further away from rotation axis L of the main shaft 100, which is shown as a white circle 390 at the center of the main shaft.

When the flaps 400 leave PA and arrive in the downwind location at PB as shown in sail 200b, the flaps 400 begin to rotate about the rotation axis and are in a slightly open to fully open state. Then, when the flaps 400 leave PB and arrive at PC, as shown in sail 200c, the flaps 400 completely rotate about the rotation axis and are in the fully open state. The reason for this is that when the sail 200c is in the upwind rotation, there is a pressure on the side of the sail 200c facing the wind, while there will be a suction force in a downwind face of the sail 200c. it should be noted that the restriction wires 335 are located in the upwind face of the sail.

The combined effect of the pressure, suction and the location of restriction wires 335 force the flaps 400 to open. In short, retention wires 335 prevent the flaps 400 from opening in the downwind direction, while allowing the flaps 400 to move freely in the upwind direction. Based on the above description, the flaps 400 act as a check valve for the assembly 1 without requiring a mechanism to open and close the flaps 400 and the wind is doing all the work.

Moreover, the opening and closing of the flaps 400 is controlled by the wind, therefore the motion of these flaps 400 will appear to be random when in the partially to nearly fully open state. Since the size of the sails 200a-d will need to be large enough to produce a useful amount of energy, the wind will “strike” the flaps 400 of the sails 200a-d with varying force, coming from varying directions, and at different parts of the sails 200a-d.

The restriction wires 335 adequately retain the flaps 400 when the corresponding sail 200a-d is in a downwind location (e.g., PA). However, when any one of the sails 200a-d is moving toward the upward direction (e.g., PC to PD), the flaps 400 move in any direction on the downwind face of the sail 200c. The apparently random motion of the flaps 400 should be controlled so that the flaps 400 are operating properly. This can be achieved in many ways, such as, for example, when using flaps 400 made of flexible material, a string can be attached to tip of each flap 400 connecting the flap 400 to a base of the mesh such that the string wont allow the flap 400 to rotate more then 90 degrees relative to the face of the sail 200a-d. If the flap 400 is manufactured from a rigid or non-flexible material, it is envisioned that the rigid nature of the flap 400 will suffice to control the flap 400, however, it is within the scope of the invention for the designer of the assembly 1 to configure a mechanism (if deemed necessary) to control the flap 400.

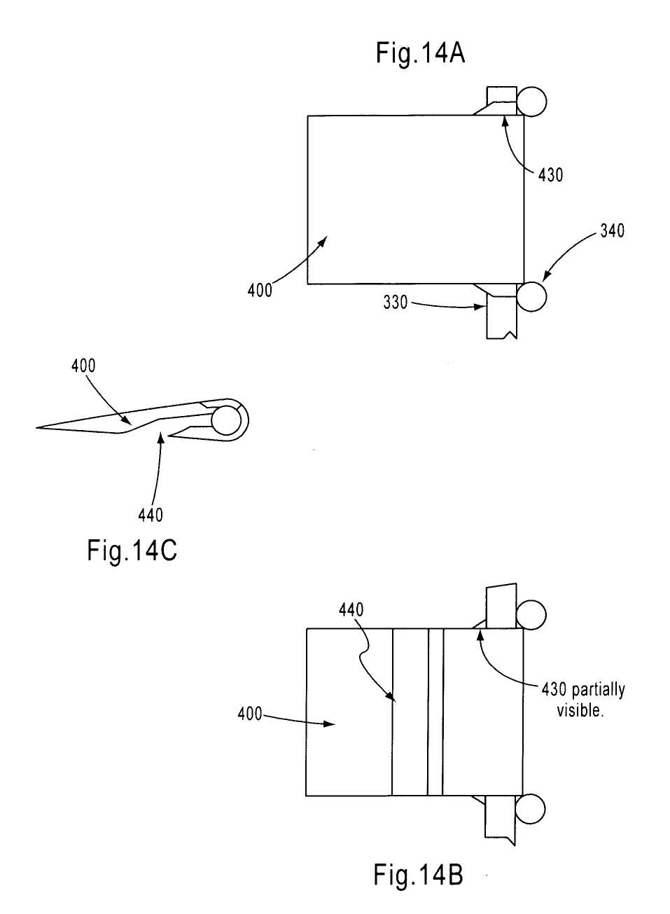

FIGS. 13A and 13B also illustrate how the flaps 400 operate. To better understand the following description, it should be presumed that the wind direction is from right to left when viewing FIGS. 13A and 13B. FIG. 13A shows the flaps 400 in a fully closed position, that is, PA in FIG. 12 and FIG. 13B shows the flaps 400 in the fully open state, that is, PC in FIG. 12. it should also be noted that the cross-section view of the flaps 400 in FIGS. 13A and 13B are merely illustrative and that the flaps 400 are envisioned to have any suitable configuration that will allow the flaps 400 to rotate about their respective rotation axis and be able to “capture” the wind while the sails 200a-d are rotating about the main shaft 100. It should also be noted that when the sail 200a at PA rotates to position PC, the wire configuration will be similar to the sail 200c at PC.

As shown in FIG. 13B, the flaps 400 include at least a clasp member 440 used to removably attach the flaps 400 to the corresponding wires, and an extended portion 430, shown in black, which limits the rotation of the flaps 400 to 90 degrees and are hereinafter referred to as rotation restrictors 430. The rotation restrictors 430 play a vital role when the centrifugal forces and air speed experienced during rotation of the assembly 1 forces the flaps 400 to open as much as possible as the extended portions limit the extent of the flaps 400 rotation about the rotation axis. In this configuration, when the sails 200a-d are at their lowest position PB and highest position PD with respect to the wind, the sails 200a-d will operate as a drag base wind turbine at position PA and operate like a lift sail type wind turbine at the PB and/or PD positions.

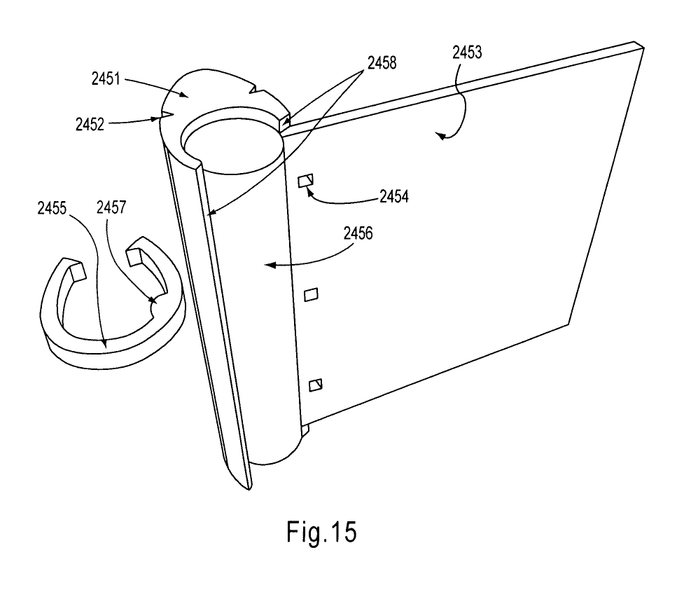

FIGS. 14A and 14B show the flaps 400 in the open position from the top and bottom views, respectively. The rotation restrictors 430 react with the wire 340 to prevent the flap 400 from rotating more than 90 degrees relative to the wire 340. As stated above, the clasp member 440 is used to mount the flaps 400 on to the wire 330. FIG. 14C provides a side view of the flap 400 for reference to FIGS. 14A and 14B.

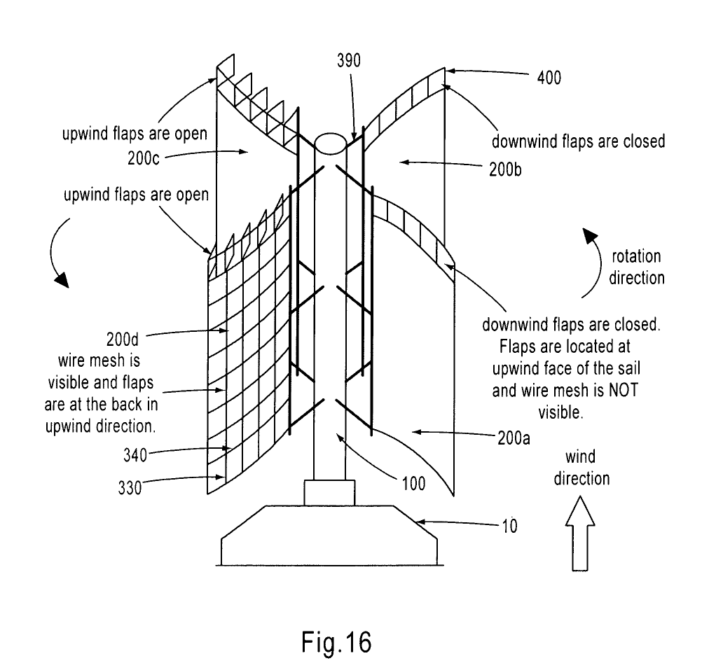

It is not necessary for the flaps 400 to rotate around the wires 340. For example, in some circumstances it may be advantageous to rotate the flaps 400 in extruded grooves, as shown in FIG. 15. The flap rotation axis 2456 may be placed on an extruded aluminum profile 2451, for example. In order to hold the flaps 400 on the extruded aluminum profile 2451, a snap ring 2455, which may be made of plastic or any other suitable material, may be pushed through a hole 2454 to snap fit in grooves 2452. In order to further secure the position of the flap 400, circumferential grooves (not shown) may be provided on the flap 400 to hold the snap rings 2455 in place. Extension 2457 may be used to close the gap between the snap ring 2455 and rotation axis 2456 of the flap 400. Because the diameter of the rotation axis 2456 of the flap 400 is smaller then the diameter of the snap ring 2455, extension 2457 will compensate for this difference and hold the flap 2453 securely in place.

Rotation angles may be restricted by construction of the extruded aluminum profile 2451. For example, as shown in FIG. 15, rotation is restricted to 135 degrees, which is beneficial under certain circumstances because it's much like giving an extra push to the sail when the sail is in transition from the downwind direction to upwind direction. By restricting the rotation to 135 degrees, the flap 400 can be used to generate thrust beyond its lowest position in the downwind rotation just when it is about to begin its upwind motion. In these positions, the flaps 400 act like a race car back flap which pushes the car downward. In the turbine, this force will create extra rotation moment. Other possible benefits of this design may be the elimination of rotation restrictors. Because the flaps 400 are not touching anything (like rotation restrictors) and the impact of the flap 400 to tube edge 2458 occurs in lower velocities when it is switching from the closed position to the open position, a reduction in noise may be achieved. Using lightweight material, such as aluminum, allow for a lighter design because the hollow tube is lighter and the restrictors may be eliminated, further reducing weight. Mounting and dismounting of the flaps 400 may be faster and the flaps 400 themselves may be cheaper to manufacture.

The present invention may be considered a hybrid between the Giromill and Darrieus designs of a VAWT. As shown in FIG. 12, the invention creates a maximum torque at position PA of the sail 200a, however, Giromills create maximum torque when the sails are at the PB and PD positions. Since this invention works much like the Giromill and Darrieus designs, it will generate torque at PA, PB and/or PD positions. In the present invention, it is believed that a torque is generated for over half of the rotation sweep of the assembly 1 except in the vicinity of the PC position.

An advantageous alignment for the flaps is for the rotation axis to be vertical because it will create the Giromill effect; however this position is not a requirement. There may be some applications which may require different arrangements. It may be desirable to arrange the flaps 400 horizontally. In the vertical alignment the opening and closing of the flaps 400 are done by the wind, however in the horizontal alignment the closing of the flaps 400 will be accomplished by gravity while the opening of the flaps 400 will be done by the wind. When the sails are moving from position PA to position PB, the flaps 400 will begin to open prematurely, however this premature opening will not cause power loss due to the Giromill effect. The premature opening of the flaps 400 may cause some noise and since noise is not desirable, it should be prevented.

If the flaps 400 are arranged in the horizontal rotational axis, wind will not be able to open the flaps 400 very easily when the sail is in the PB position because of the flap configuration. Due to the horizontal alignment of the flaps 400, the flaps 400 will be in a closed configuration around the PB position. However, when the sail is approaching the PC position from the PB position, the strength of the wind will cause the flaps 400 to open automatically. The opening process will gradually occur such any creation of noise will be reduced.

Wind will be stronger upon an upwind sail, position PC, than a downwind sail, position PA, because while wind is blowing downwind the sail in position PC is moving in the upwind direction. Therefore, the relative wind speed with respect to sail at position PC will be the speed of the wind plus the speed of the sail. On the other hand when the sail, in position PA, is moving in the downwind direction, the relative wind speed with respect to the sail at position PA will be the wind speed minus the speed of the sail. This is one of the main reasons why some VAWTs are inefficient, the upwind moving sail creates so much drag that the system fights against this drag instead of producing valuable energy. By opening the flaps 400 on the upwind direction, drag will be reduced substantially, thus increasing the overall system efficiency.

It is also within the scope of this invention that the alignment of the flaps 400 be oblique rather than horizontal or vertical. In this embodiment, the opening of the flaps 400 will be done by the wind while closing of the flaps 400 will be done by the combined effects of gravity and wind. The orientation of the oblique angle will determine whether wind or gravity will be stronger.

The rotation axis of each flap 400 can also be at any location as long as it performs the check valve function against the wind. Therefore, the flaps 400 will be closed in the downwind and open in the upwind direction, a key principle of this invention.

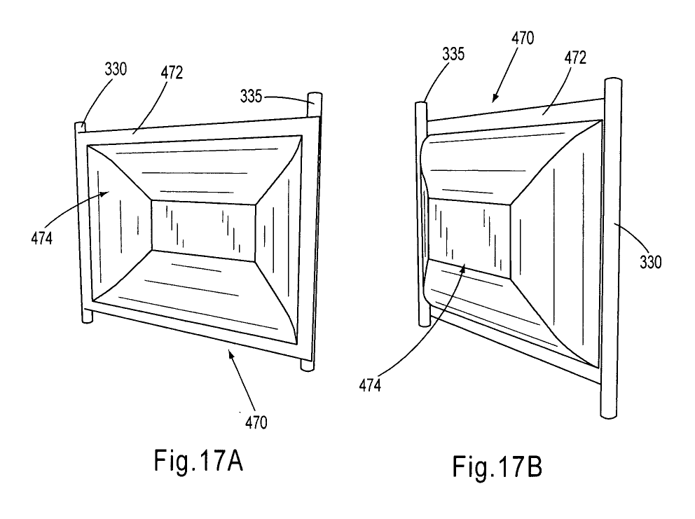

The grid structure composed of wires 330 and 340 can also be arranged such that they create a curved sail much like a scoop. FIG. 16 shows the arrangement of a rigid sailed VAWT where the sails have a curvature allowing them to have a scoop-like structure. Unlike the above described turbine, which rotates clockwise (CW), the turbine assembly of this embodiment rotates in the counter clock wise (CCW) direction. Turbines can be arranged to rotate in any direction simply by rearranging the sail structure.

With this invention, the design of the VAWT can be handled in many ways. It is not necessary that the sub-grid 320 be a wire and the flaps 400 be made of semi rigid material. It is within the scope of this invention to design a VAWT where the sub-grid is rigid and the flaps 400 are flexible. It is also equally possible to have both the sub-grid and flaps be flexible.

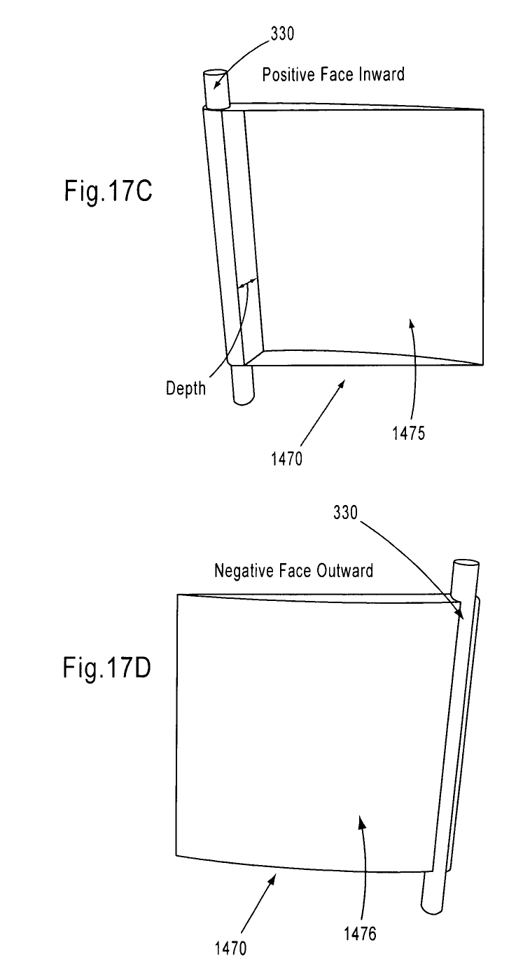

For example, FIGS. 17A and 17B show a flexible membrane flap 470 for increasing the efficiency of capturing the force of a fluid in a downstream direction. The membrane flap 470 has rigid frame 472 that surrounds and supports a flexible membrane member 474. The membrane flap 470 may rotate around the vertical wire 330, for example, while the restriction wire 335 supports the rigid frame 472 in a closed position. The flexible membrane member 474 bends inward and creates a bucket shape which creates a greater drag in the path of a fluid. The membrane flap 470 increases the efficiency of the check-valve turbine in a manner similar to, but greater than, the Savonious curved turbine sails. Fluid collected in the bucket shape of the membrane member 474 is pushed outward toward the end of the downstream motion which generates an extra push for the sails. The fluid filled membrane member 474 may also prevent the membrane flap 470 from moving to an open position prematurely which may reduce noise. On the upstream stroke, the membrane member 474 will return to its original shape and reduce drag while the flap 470 is open. FIG. 17B shows the membrane flap 470 from behind when filled by fluid in a downstream direction.

FIGS. 17C and 17D show another aspect of the invention in which rigid square scoop shape plastic flaps 1470 may be provided to function in a similar manner as the membrane flaps 470 described above. It should be emphasized that the depth of the scoop portion 1471, as shown in FIG. 17C, should not be larger than the projected area of the flap 1470 around the wire 330, for example. The thickness of wire 330, plus the thickness of the plastic around the wire 330, should determine the maximum depth of the scoop portion of the scoop flap 1470. The scoop flap 1470 may reduce manufacturing costs while maintaining the effectiveness of a membrane flap. In FIG. 17C, a positive face 1475 is the face of the flap 1470 as viewed in the closed position in a downward motion (PA). FIG. 17D is a view of the negative face, or the back face 1476, of scoop flap 1470, wherein the back face 1476 has a curving profile.

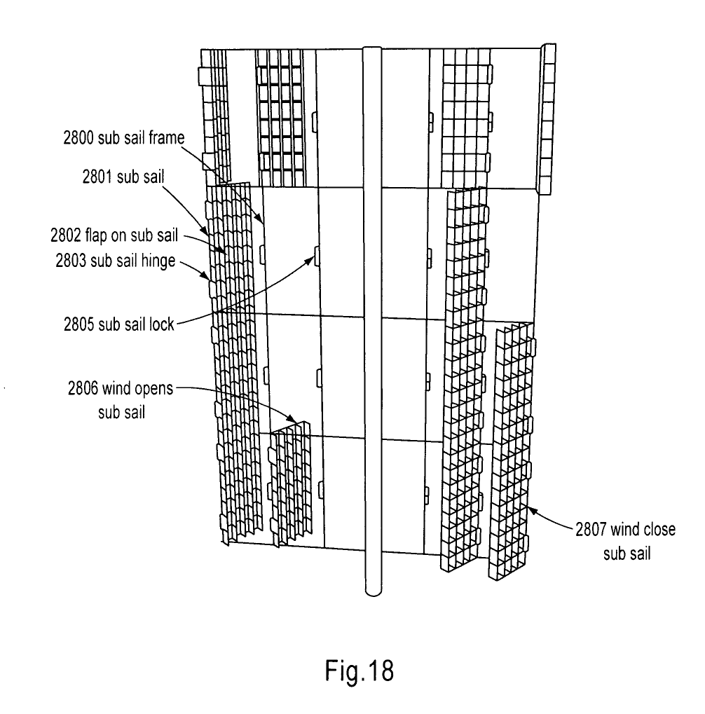

FIG. 18 illustrates a sub-grid assembly in which the sub-grid comprises sub-sails 2801. Any power producing rotational machine should have a mechanism to stop the machine completely under extreme conditions or for maintenance. For example water or steam turbines cut the water or steam supply coming to these turbines to stop their operation completely. The bladed horizontal wind turbines have pitch motors which changes the orientation of the blades to that of the least resistant position and uses braking power to stop the machines. A check-valve turbine without such a mechanism would be useless, since there is no way of stopping the machine under extreme conditions or for maintenance purposes, during extremely windy conditions. To use a braking system, without force reduction, on the sails will require a very expensive mechanism to stop the turbine. To overcome this difficulty, sails will be constructed with sub-sails attached to them.

If a sail resembles a rectangular wall, then sub sails are much like doors attached to the wall. The flaps 2802 are attached to the grid on each individual door. The doors are able to rotate 90 degrees on the sails, while the flaps 2802 are able to rotate 180 degrees on the grid attached to the door. For optimum performance, the rotation axis of the doors and flaps 2802 should be parallel; however, this is not a requirement. FIG. 18 illustrates an example of a wind turbine not in operation during the maintenance state when there is no wind acting on the turbine. Some of the sub-sails 2801 are removed to show the underlying sail frame 2800 which holds the sub-sails 2801. In this example, the sub-sails 2801 are attached to a sub-sail frame 2800 by sub-sail hinges 2803. Sub-sail locks 2805 hold the sub-sails 2801 in the closed position during normal operation of the turbine and are able to rotate 90 degrees when the locks 2805 are released. The locks 2805 may be released during maintenance and extreme weather conditions to cease operation of the turbine. During regular operation, the locks 2805 will not allow the doors to swing, thus sail and sub-sail 2801 will act as regular sails. When there is an emergency, the locks 2805 may be released by an electronic mechanism to let the sub-sail 2801 swing (or rotate) freely. Once the locks 2805 are released, there is no way the turbine can maintain rotation, because upwind sail flaps 2802 are open and do not show any resistance to the wind. At the same time, downwind, the sub-sails 2801 open and there is no resistance to the wind. A braking mechanism may be further provided to stop the turbine completely and prevent the injury of personnel, for example, if the wind changes direction suddenly, which might cause the turbine to make some movement but not complete a rotation.

The flaps 2802 are attached on the sub sail 2801 and are able to rotate up to 180 degrees. The open sub sails 2801 may be brought to the closed position with a self closing mechanism similar to those used on self closing doors, such as a spring-loaded hinge or air-controlled piston (not shown), for example, or by tilting the sub sail frame 2800 to some appropriate angle which would cause the sub sails 2801 to close by gravity.

A rubber-like shock absorber (not shown) may be attached to the sub sail frame 2800 to protect the sub sails 2801 from damage in case they strike the sub sail frame 2800. Also, the sub sails 2801 may be designed to open rapidly, while closing may be slower and gradual to reduce the chances of the door slamming and becoming damaged or creating a lot of noise.

When the strength of the wind is reduced from dangerous levels but still has some strength, the sub sails 2801 on the upwind side of the sail may be closed by the self closing mechanism; since the flaps 2802 on the sub sails 2801 would be in an open condition. However, the sub sails 2801 attached on the downwind sail will not be closed. This is because the flaps 2802 are closed in this position. While the self closing mechanism may push the sub sail 2801 toward a closed position, the wind will try to maintain the sub sail 2801 in an open position due to closed flaps 2802. This will make the turbine inoperable. To overcome this, a motor may be provided on the turbine axis to give the turbine a 180 degree rotation, which will force all the sub sails 2801 to the closed position and allow the turbine to be operable again.

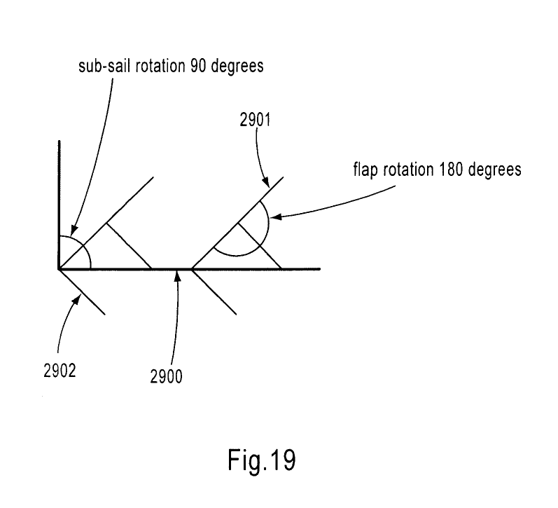

FIG. 19 shows the top view of a sail 2900 with 2 columns of sub-sails 2901 attached. FIG. 19 also shows two columns of flaps 2902 attached to the sub sails 2901.

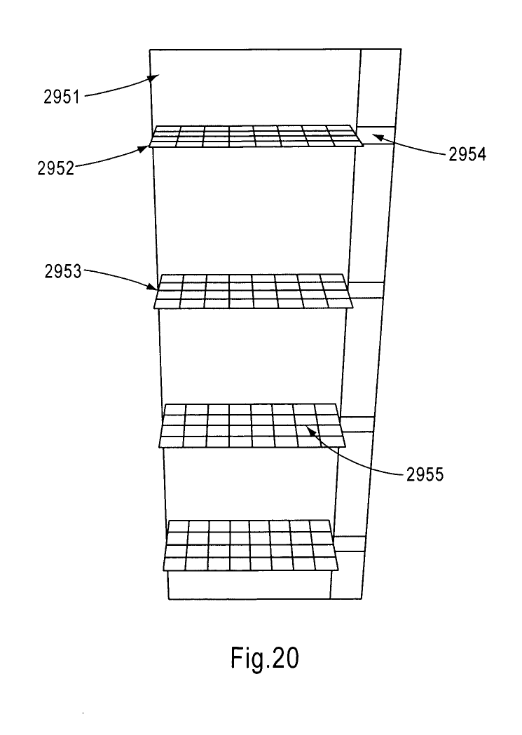

While the door-like sub sails 2901 may be easy to construct and operate, they may not be appropriate for particular applications. For example, a boat operating with a check-valve turbine may not be suitable for operation, under certain conditions, with door-like sub sails. The waves in the ocean may make the sub sails act violently. Rotating sub sails 2952, similar to those shown in FIG. 20, may be implemented. In this configuration, rotating sub sails 2952 are attached to the sail frame 2951 by a rotation bearing 2953 and rotation motor 2954. The sub sails 2952 may rotate on a horizontal axis such that when they are rotated, the sub sail surface may be generally parallel to a horizontal plane. As shown in FIG. 20, during extreme wind conditions, the motor 2954 may rotate the sub sail 2952 ninety (90) degrees to an open state. When the wind speed is reduced from dangerous levels, the motors 2954 may rotate the sub sail 2952 ninety (90) degrees in an opposite direction to bring the turbine to normal operating conditions. Although described above with a specific range of motion, the sub-sails 2952 may rotate 360 degrees in any direction to provide maximum flexibility to the sub sails 2952.

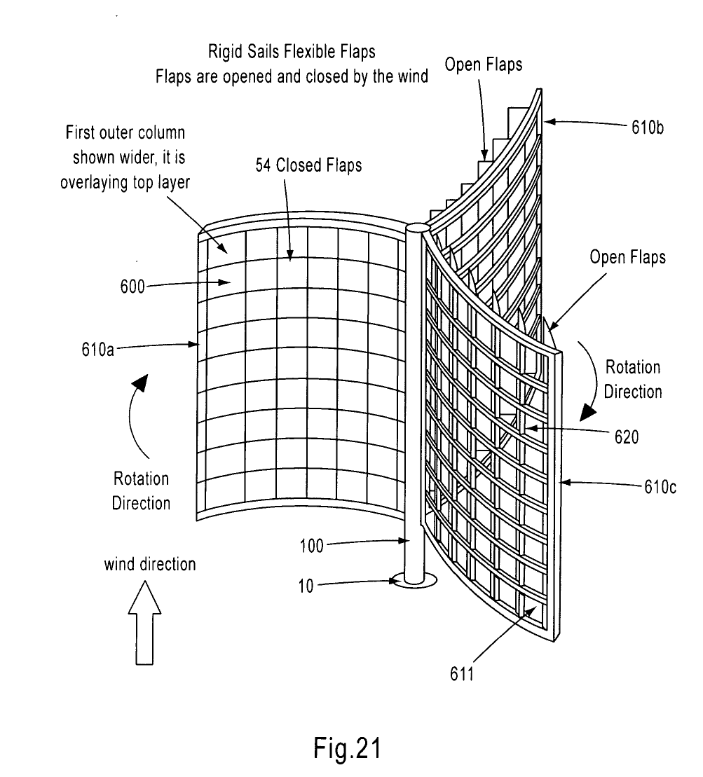

FIG. 21 illustrates according to yet another embodiment of the sail 200a where the underlying grid is made of suitable material (metal, plastic, etc.) with holes 611 on it for the wind to pass through in the upwind movement of the sail. In this case, the flexible flaps 600 are attached to the sub-layer grid by an adhesive, e.g., a glue, or any other suitable adhesive mechanism. The flexible flaps 600 should be made of bendable material unlike the flaps 400, which are made of semi rigid material. The bendable material for the flexible flap 600 can be rubber, plastic, leader, Kevlar or fabric, Note that the flexible flaps 600 are not rotating but are attached to the grid from one edge of the flap and that the opening and closing of the flap is accomplished by the bending of the flexible flap 600 by the wind.

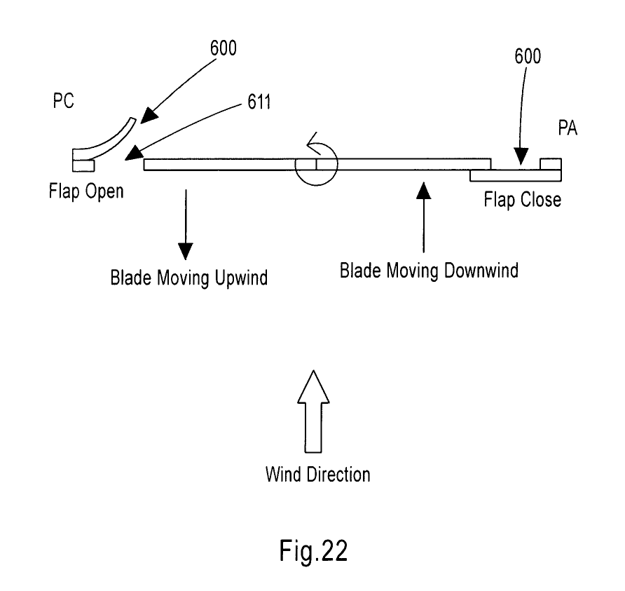

FIG. 22 is a plan or top view of a flexible flap 600 attached to a rigid base and which is not able to freely rotate. Rather, in this embodiment, the flaps 600 restrain themselves from rotating more than 90 degrees. It is important to note that the flaps 600 are flexible enough to bend, yet strong enough to cover the hole 611 without passing through to the other side. The flaps 600 close the holes 611 simply by being in a closed position because the flaps 600 are dimensioned to overlap the hole. To further prevent the flexible flaps 600 from passing through the holes 611, a coarse mesh may be attached to the holes 611.

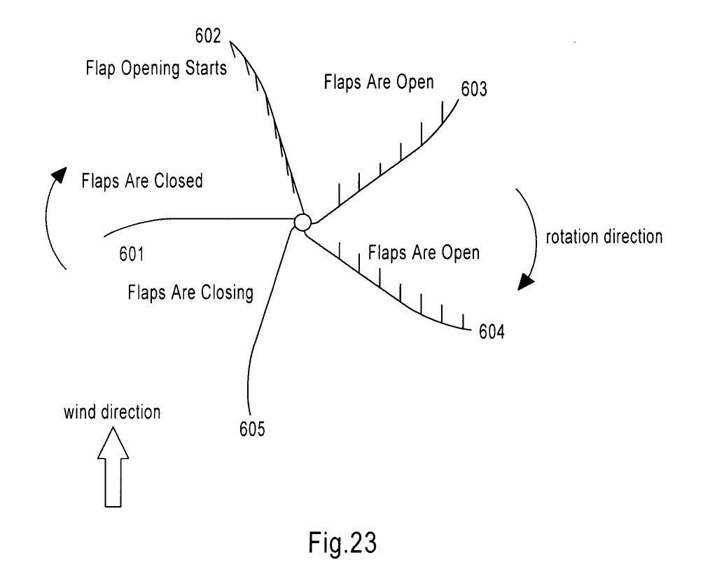

FIG. 23 is a schematic diagram of a plan or top view of a VAWT with five rigid sails having flexible flaps. FIG. 23 shows how each of the sails operate at different positions during the rotation lifecycle. The flexible flaps 600 are attached to the sail perpendicularly such that while in position 601, the flaps 600 are in the fully closed state; when in position 602, the flaps 600 are in the partially open state; when in positions 603 and 604, the flaps 600 are in the fully open state, and in position 605, the flaps 600 are again in the fully closed state. It is important to note that the flexible flaps 600 should be larger than the holes 611, otherwise the wind may force the flaps 600 through the holes 611 and make the sails inoperable. If necessary, some type of wire or net may be added to prevent the flexible flaps 600 from passing through the holes 611.

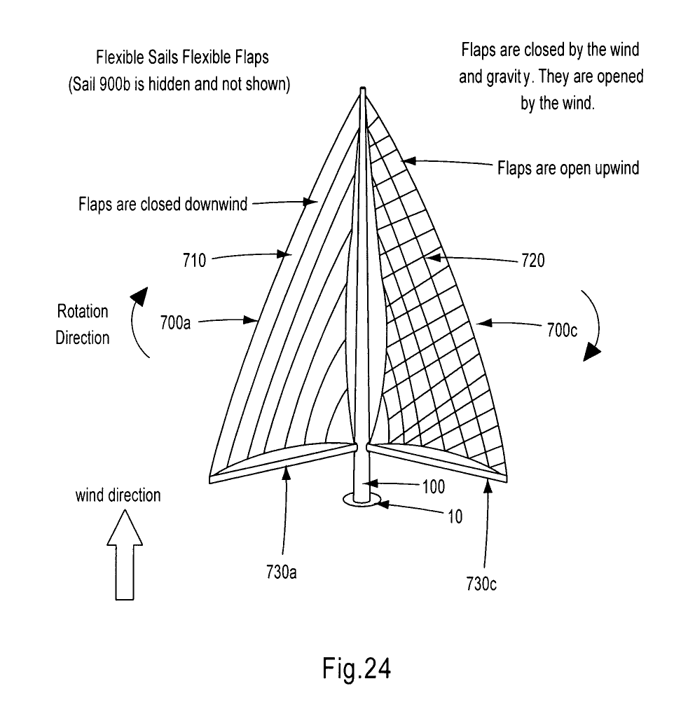

It is also possible that both the sails and flaps are made of flexible materials. Actually, it is suitable, or alternatively, for some application to have flexible sails. FIG. 24 illustrates yet another embodiment of the present invention wherein a flexible sail is used with a sail boat to power the boat. This kind of construction will be similar to commonly known single-layer sailboat sails, but wherein the sail is made of two layers instead of the conventional single layer sail. In this embodiment, the base grid will be similar to a net 720 having flexible flaps 710 attached thereon.

Rather than having solid sails, the sails may be built with flexible material, as illustrated in FIG. 24, to allow the sails to be foldable so that in case of a storm, the boat will not be subjected to too much force. The sails may have a grid sub-layer 720 made of net and the flaps 710 may be attached thereto at an oblique angle wherein gravity and the wind will close the flaps in the downwind rotation. On the upwind rotation, the flaps 710 will be opened by the wind to reduce the drag on the sail. As shown in FIG. 24, the third sail 700b is hidden from the view. The sails used to propel the boat rather than push the boat, as is the case with conventional sailboats.

This simple structure can also be used with irrigation and other power requiring systems where such turbines can be manufactured using local resources and without requiring expensive material.

Until this point, each of the embodiments of the inventive VAWTs described herein have two layers on the sail to create the check valve action and to enable the turbines to work properly wherein the first layer is a mesh like structure and the second layer includes the flaps operating on the mesh. The purpose of the mesh is to restrict the flaps from moving in unwanted directions. This design is easy to build, however it is not the only way to create a sail where the flaps act as a check valve. The primary emphasis of this invention is to have flaps act as a check valve. Therefore it is within the scope of this invention to have flaps act as a check valve whether there is an underlying mesh structure or not.

There are many ways to make the flaps act as a check valve and as an example, a sail where there is no mesh structure and the flaps alone act as a check valve will be described.

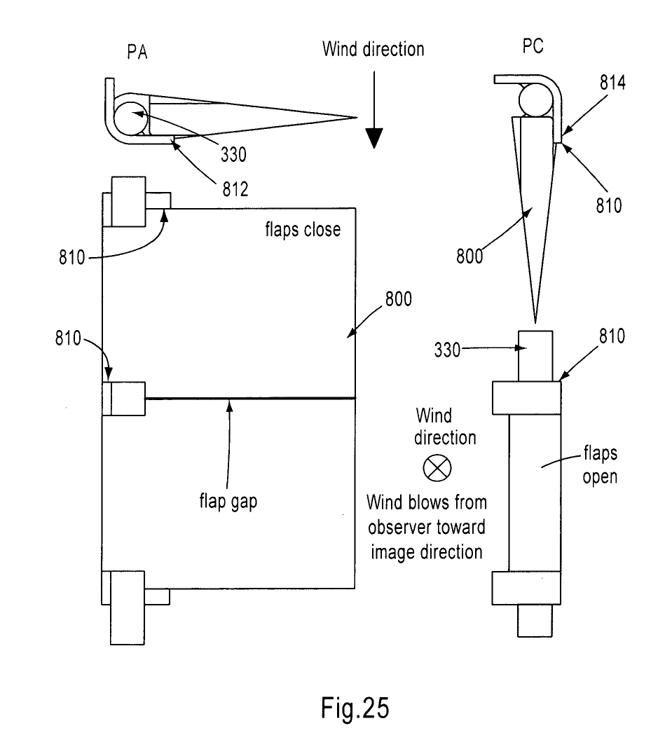

FIG. 25 shows a system where the flaps 800 act as a check valve. The vertical wires 330 will still be present with this arrangement, however; the horizontal wires have been replaced by an L-shaped strip 810, which plays the same role as the horizontal wires. The L-shaped strip may be made of any suitable material, including lightweight metals such as aluminum, for example. The L-shaped strips 810, which have a rectangular cross section (one side is longer than the other), have at least two functions. A function is to restrict rotation of the flaps 800 to 90 degrees. Thus, the restriction of rotation is shifted from the earlike structure 430 to the L-shaped strip 810 in this embodiment. Another function is to eliminate the horizontal wires 340, which were used to keep the flaps 400 equally spaced, vertically, from the system. The clasp member length 830 between flaps 800 is adjusted by the distance of L-shaped strips 810. Eliminating the long wires 340 with small L-shaped strips 810 substantially reduces the weight of the sails, makes it lighter, and is relatively easy to manufacture. This type of turbine also exerts enormous centrifugal force because the weight distribution of the sail is further away from main shaft 100. This is significant because any weight reduction has an enormous impact on overall system performance.

The operation principle of the flaps 800 is simple. When the sail is in the PA position, wind forces the flap 800 to close, and the arm 812 of L-shaped strip 810 prevents the flap 800 from moving more than a desired angle, regardless of whether the flaps 800 are overlapping or not. On the other hand, when the sail is in the PC position, the wind forces the flap 800 to open, but arm 814 of the L-shaped strip 810 will prevent flap 800 from rotating more than 90 degrees relative to the wire 330.

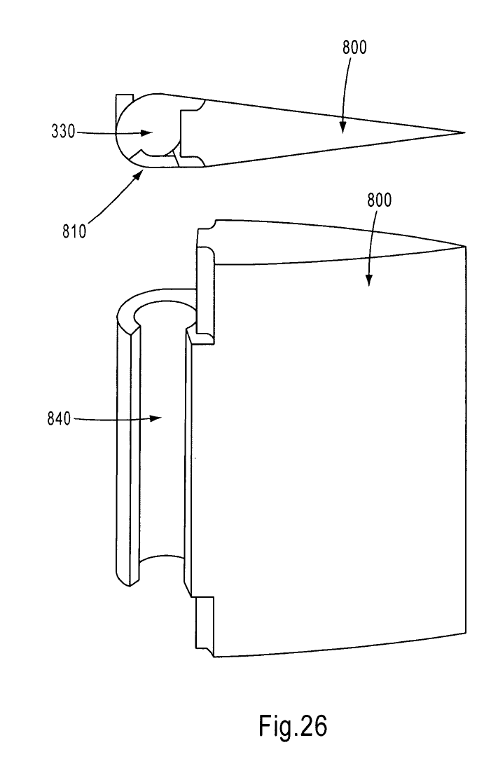

FIG. 26 shows a close up view of the flap 800. In this embodiment, the extension 430 is not present. Instead, the flap 800 has a section where the L-shaped strip 810 operates and the rotation hole 840 does not extend along the entire length of the flap 800 to make room for the L-shaped strip 810 to operate on both ends of the flap 800. In this embodiment, the clasp member 840 is different than the clasp member 440 discussed above. It is within the scope of the present invention to have any suitable attachment mechanism that permits the flap 800 to operate as check valve. It is also important to note that as a result of the structure and location of the clasp member 440, once the clasp member 440 grabs the wire, wind cannot dislodge the flap 800 therefrom. The flaps 800 may also be made of two rigid flaps screwed to each other around the wire.

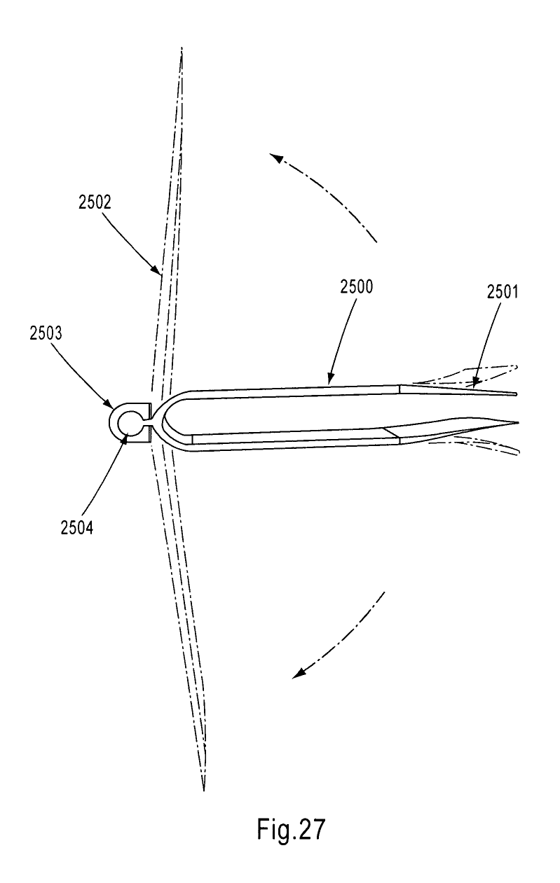

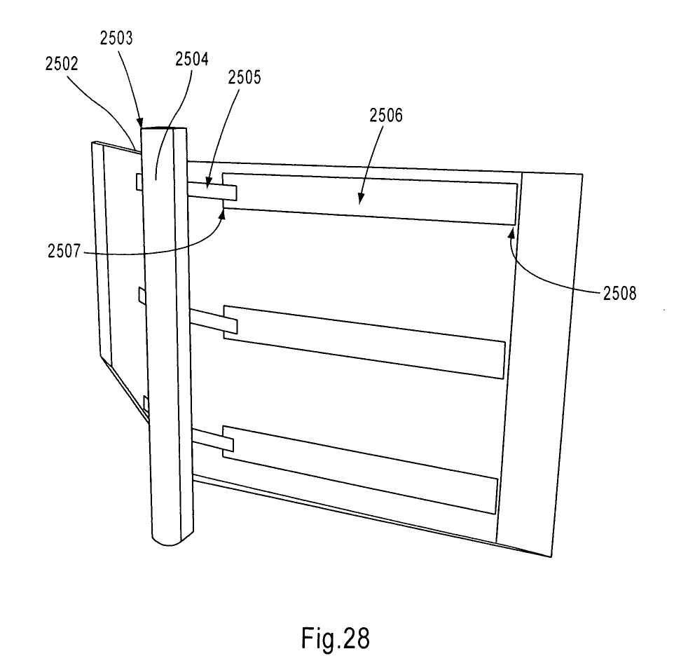

Furthermore, a flap 2500 may be provided that serves the check-valve principle without rotation about a wire or within a tube, for example. Rather, at least two panels 2502 of flap 2500 may attach to a main base 2504, as shown in FIGS. 27-28. The panels 2502 may be manufactured from an elastic material which can change its shape, or bend, as the result of the force of the wind, for example.

In FIG. 27 the flap 2500 is shown in 3 different stages. This type of flap operates best when the flap base 2504 is horizontal to the ground. The center position is showing the shape of the flap 2500 when there is no wind acting on the panels 2502 (manufactured position). Note that the free ends or tips (2501) of the panels are thinner and may be bent outward. This allows the air to enter easily and bend the elastic panels 2502 into an open position. When the flap 2500 moves against the wind, the panels 2502 are bending inward toward each other and create an airfoil shape which reduces the drag caused by the wind. When the sail is moving in the downwind direction, the flexible material bends and the panels 2502 open to capture the wind coming towards the sails. The flaps 2500 may be placed in an extruded aluminum profile 2503 where the longitudinal end of the profile 2503 nearest the panels 2502 is flat to act as a supporting base for the opened flaps and to restrict their rotation.

FIG. 28 shows that the aluminum profile 2503 may have fin like extensions 2505 to prevent the elastic panels 2502 from bending beyond a certain position. Because the panels 2502 are very elastic, the fin 2505 will not completely prevent the panels 2502 from bending backward. To further prevent backward bending, strips 2506 may be attached by glue, or any other suitable means, onto the panels 2502. The strips 2506 may be composed of a suitable material, including a lightweight metal or plastic, for example. The number of strips 2506 may be determined by experiment, taking into account the flexibility of the material, for example. The interior end 2507 of the strip 2506 closest to the aluminum profile 2503 may have be situated some distance from the center to allow the panel 2502 to bend easily. If the interior end 2507 went all the way to the center of the aluminum profile 2503, the panels 2502 would have difficulty bending inward. A section of fin 2505 may overlap the strip 2506 to give support to strip 2506 so that it does not bend backward when the panels 2502 fully open. The second end 2508 of the strip 2506 should not extend all the way to the free end or tip 2501 of the panel 2502. There may be a gap provided or the strip 2506 may become thinner toward the free end or tip 2501 of the panel 2502. The strips 2506 provide structure to the panel 2502 membrane to maintain shape. Narrowing the strip 2506 toward the tip 2501 of the panel 2502 may keep the panel's (2502) shape in moderate speeds, but may bend backward just like an umbrella turning inside out under strong wind which may act like relief valve. The fins 2505 will restrict opening of the flaps 2500 to 180 degrees. Because there is no sudden direction change, the flaps 2500 may operate more quietly.

During operation of the check-valve turbine, extremely high wind speeds, for example, or sudden gusts of wind, may pose a danger to the operation of the turbine. The force of the wind on the sail, combined with the inertia of the system, could be strong enough to damage or destroy the sails, for example, or the entire turbine system. To prevent this from happening, some or all of the flaps in a check-valve turbine may be constructed with relief mechanisms that open in response to a predetermined load to reduce the force on the system and prevent damage or destruction. The flaps, being smaller than the whole sail itself, carry a smaller inertia, thereby enabling the flaps to react quicker to sudden changes in load than would the entire sail.

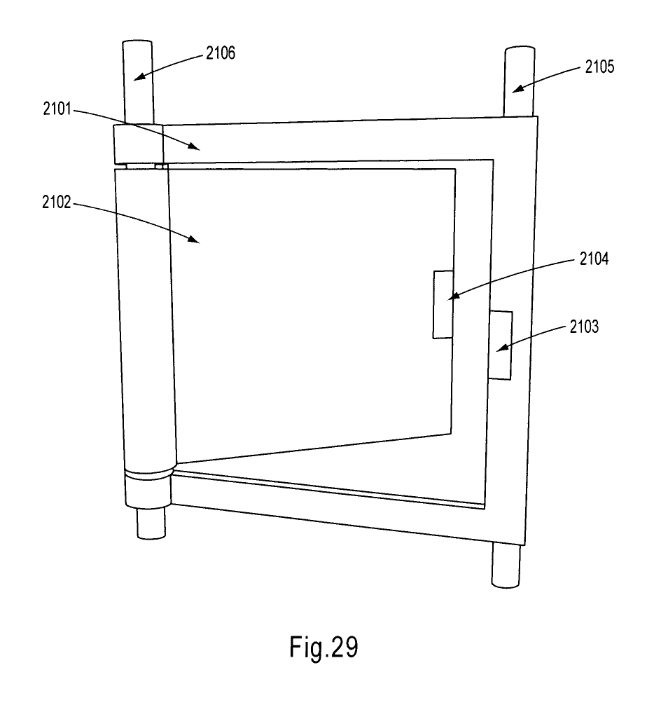

FIG. 29 shows an embodiment of a relief mechanism having a relief flap 2100 that comprises a U-shaped primary flap member 2101 and a rectangular secondary flap member 2102, for example. The independent flap members 2101 and 2102 rotate around the same axis, which may be a horizontal or vertical lattice member, for example. A ferrous metal strip 2103 may be attached on an inner perimeter surface of the outer flap member 2101 and a magnetic strip 2104 may be attached on a distal end of the inner flap member 2102, as shown in FIG. 29. Although described in this manner, the magnetic strip 2104 may be attached to an inner perimeter surface of the outer flap member 2101 and the ferrous metal strip 2104 may be attached to the distal end of the inner flap member 2102, or along any outer perimeter surface of the inner flap member 2102, for example. The metal strip 2103 and the magnetic strip 2104 may be designed to be attached to, or embedded in, the flap members and dimensioned to function as described herein without adding significant weight to the check-valve turbine.

The ferrous metal strip 2103 and the magnetic strip 2104 are situated to adjacently align when the inner flap member 2102 swings through the outer flap member 2101. Under normal operating conditions, planar alignment of the outer and inner flap members, 2101 and 2102, respectively, is maintained due to magnetic attraction between the ferrous metal strip 2103 and the magnetic strip 2104, which ensures that the relief flap 2100 acts as a single relief mechanism or unit. However, when the wind speed increases to a predetermined level, the forces acting on the inner flap member 2102 will break the magnetic connection between the strips 2103 and 2104 to allow the inner flap member 2102 to swing open and away from the outer flap member 2101. The sail should be designed so that the supporting mesh does not interfere with the opening motion of the inner flap member 2102. The inner flap member 2102 swings open freely to substantially relieve the forces from the wind on the combined relief flap 2100. A small gap may exist between the inner perimeter of the U-shaped outer flap member 2101 and the outer perimeter of the inner flap member 2102 to reduce any noise resulting from the engagement and disengagement of the relief valve.

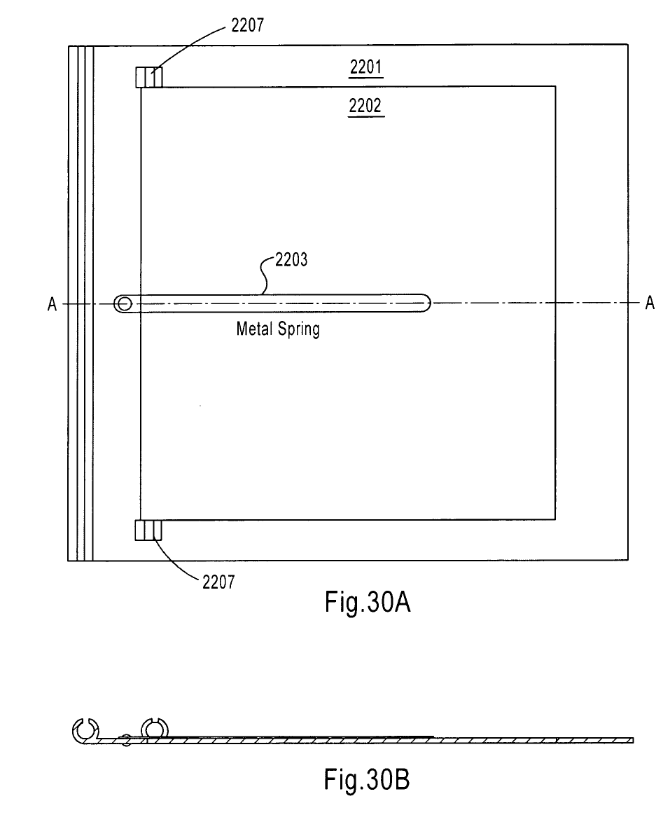

FIGS. 30A and 30B show a relief flap 2200 according to another embodiment and having an outer flap member 2201 and an inner flap member 2202. The outer flap member 2201 may have an axis of rotation about a horizontal or vertical lattice member, for example. The inner flap member 2202 has a rotation axis that is parallel to, but not the same as, the rotation axis of the outer flap member 2201. For example, as shown in FIG. 30A, hinge joints 2207 may be provided between the inner and outer flap members, 2202 and 2201, to allow the inner flap member 2202 to swing between open and closed positions. A strip spring 2203 is joined to the outer flap member 2201 and pushes the inner flap member 2202 to be in a closed position. When the wind speed reaches a predetermined level, the strip spring 2203 allows the inner flap member 2202 to open. When the increased load on the relief flap 2200 subsides, the strip spring 2203 pushes the inner flap member 2202 back to a closed position. The strip spring 2203 may be designed of lightweight metal, such as aluminum, for example, or may be composed of any suitable material that is lightweight and can be manufactured with the correct stiffness. FIG. 30B shows the cross-sectional view of the relief flap 2200 shown in 29A as taken along A-A.

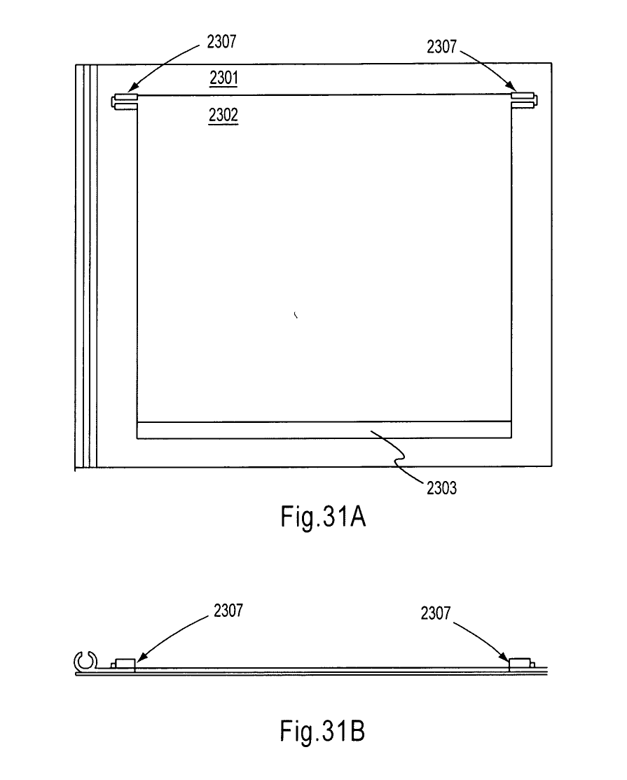

FIGS. 31A and 31B illustrate a relief flap 2300 according to yet another embodiment and having an outer flap member 2301 and an inner flap member 2302. The outer flap member 2301 may have an axis of rotation about a horizontal or vertical lattice member, for example. The inner flap member 2302 has a horizontal rotation axis that is not shared with the rotation axis of the outer flap member 2301. For example, as shown in FIG. 31A, hinge joints 2307, for example, may be provided between the inner and outer flap members, 2302 and 2301, to allow the inner flap member 2302 to swing between open and closed positions. A weighting device 2303, such as a metal strip, may be joined to the bottom of the inner flap member 2302. The weighting device 2303 relies on gravity to maintain the inner flap member 2302 in a closed position. The weight of the weighting device 2303 may be such that when the wind reaches a predetermined speed, the forces acting on the inner flap member 2302 cause the inner flap member 2302 to lift and allow wind to pass between the outer flap member 2301 and the inner flap member 2303.

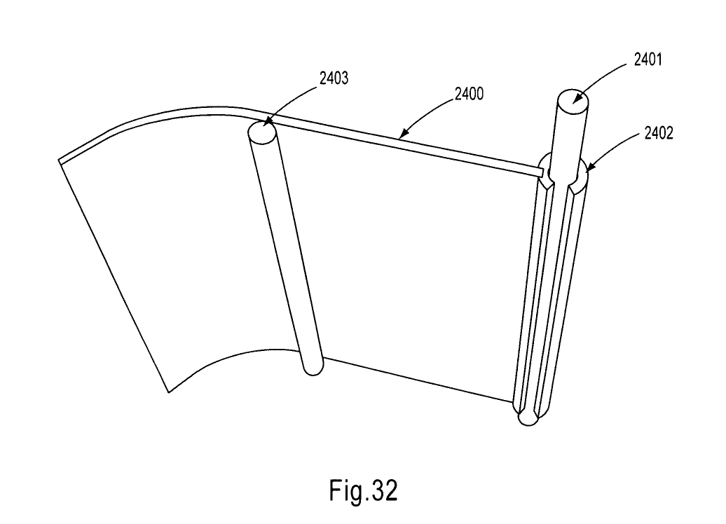

FIG. 32 shows a relief flap 2400 according to another embodiment and which is comprised of elastic material. The material keeps its initial shape in mild to moderate wind speeds and bends backward when the wind speed reaches a predetermined level. The bending allows some of the air to escape to relieve stress from the sail. As shown in FIG. 32, while the relief flap 2400 rotates around grid wire 2401, the wire 2403 restricts the rotation of the flap and keeps it in a closed position. Under normal loading conditions, the relief flap 2400 is straight. The wire 2403 may be adjusted to be of varying distance from the grid wire 2401. If the wire 2403 is closer to grid wire 2401, the relief flap 2400 bends more under moderate wind speeds. Based on the elasticity of the material of the relief flap 2400, the location of the wire 2403 is determined to enable sufficient bending at the predetermined wind speed so that air may escape and relieve pressure on the sail.

The current invention can be used as a VAWT but is not restricted to only this use. It is within the scope of this invention that the inventive check-valve with or without the relief mechanism be used as a water turbine to generate electricity or power a submergible pump in an irrigation system.

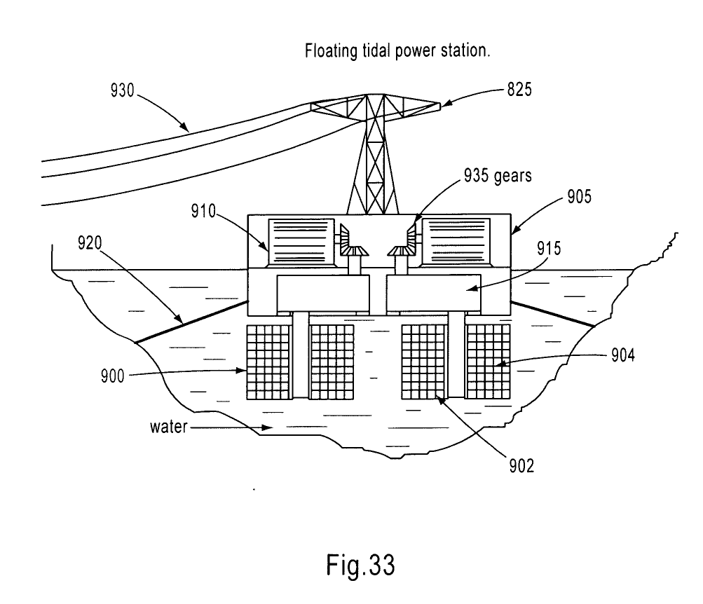

FIG. 33 illustrates a floating power plant placed, for example, in the mouth of a bay or large river where water is flowing in and out due to tidal motions. A floating platform 905 can hold two generators 910 connected by a gearbox 915 to a sail turbine 900. The power converted by the generators 910 will be transmitted through the power tower 925 via transmission wires 930. This system will operate whether water flows in or out of the bay, since this invention is omni-directional. In FIG. 33, the closed flap sails 902 are shown in a darker color than the open flap sails 904. Two turbines are shown with closed sails that are close to each other, which makes it easy to direct the flow of water through the channels (not shown in the figure) to the sails. Also, since two turbines with the closed sails are facing each other they are rotating in the opposite direction. This will stabilize the platform from making any rotations. The only force that will be exerted to the platform will be through water flow which is compensated by wires 920. Although only two turbines are shown in FIG. 33, it would be apparent to one with ordinary skill in the art that one turbine or more than two turbines may be provided.

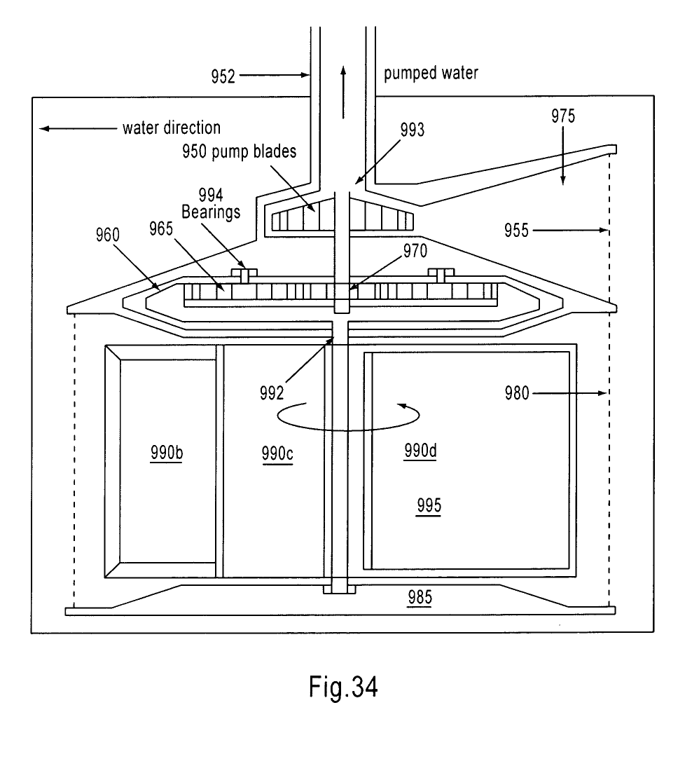

Many agricultural fields are relatively close to fast flowing rivers where the irrigation water is pumped to the fields by an internal combustion engine driven pump. Due to the rising cost of fuel needed to run such pumps and the remoteness of the fields, alternate methods for pumping the irrigation water are needed. FIG. 34 illustrates a submersible water turbine that powers an irrigation water pump.

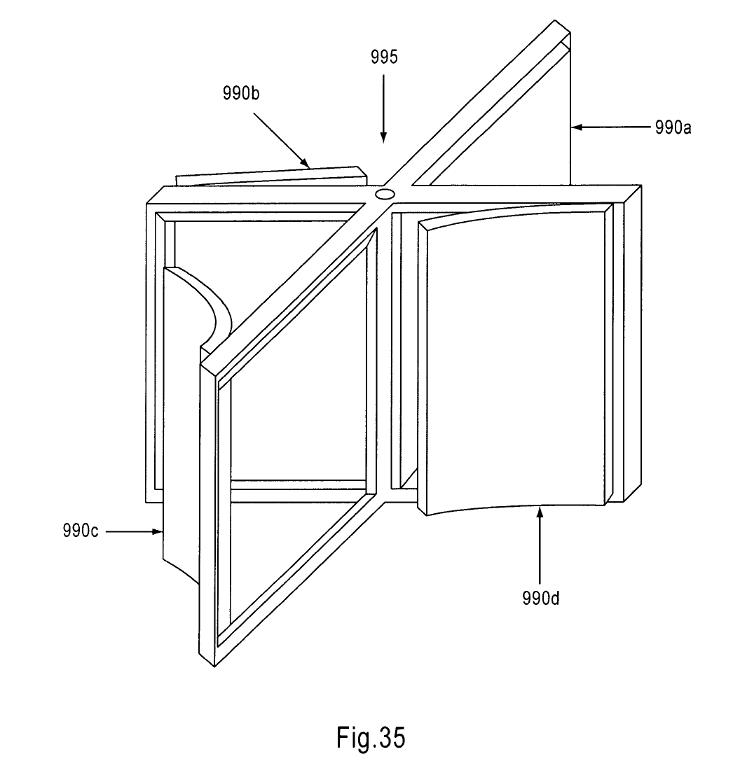

As shown in FIG. 34, the pump is powered by a vertical axis turbine 995 that operates based on the basic principals of the invention described above. While the exemplary embodiment of the turbine 995 illustrated in FIG. 34 includes four flaps 990a-d (flap 990a, which is in a closed position, is hidden from illustrated view), it is within the scope of the invention that this embodiment of the invention includes any suitable number of flaps 990 so long as there are at least two flaps 990. Moreover, as shown in FIG. 35, the flaps 990a-d are illustrated as being made from a flexible material, but it is also within the scope of the invention to manufacture the flaps 990a-d from any known or later discovered rigid or non-flexible material.

In the illustrated embodiment, because the flow of water is in the right to left direction of the figure, flap 990b is rotating into the open position, flap 990c is rotating into the closed position, and flap 990d is in the closed position. During operation, water must be channeled or directed to the turbine 995 to increase the amount of power exerted on the turbine by the water. As shown in FIG. 34, a water permeable grid, mesh or screen 955 and 980 encompasses the turbine 995 to protect the turbine 995 from debris.

In operation, the rotation of the turbine 995 is transmitted to a planetary gear mechanism through a vertical shaft 992. The shaft 992 rotates and external gear 960 of the planetary gear system and drives the planetary gears 965, which transmit a rotary motion to a sun gear 970. Another vertical shaft 993, which is coaxial with the vertical shaft 992, attaches the sun gear 970 directly to pump blades 950. The planetary gear system facilitates an increased power ration of the rotation of the turbine 995 to be transmitted to the pump blades 950.

Water enters the pump through the channel 975, which has a cross section that decreases in a direction toward the pump. The reducing cross section creates a ram effect on the water along with an increased pressure. Also, the pump blades 950 are able to add more pressure to the incoming water to force the water through a pipe 952 into a storage tank (not shown).

Recently the military has built very small planes that are used to observe remote areas as well as buildings in urban settings during combat. Due to aerodynamic constraints, it is not feasible to use fixed wing systems on small planes. Such small planes must use flapping or moving wings instead of fixed wings. The observation planes or drones currently in use by the military use an advanced control mechanism.

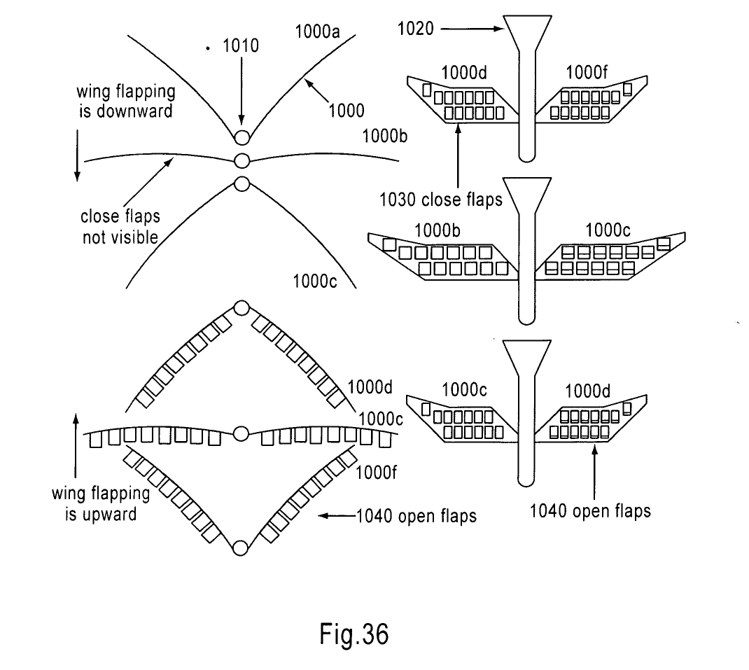

It is within the scope of this invention to use the previously described inventive check valve mechanism to assist operational control of the flapping wings. FIG. 36 illustrates a small, flapping winged airplane using check valve flaps attached to the wing. When the wing is flapping in a downward motion, as much air as possible must be pushed downward to obtain the necessary lift to stay in the air. However, when the wing is flapping upward, the air should not be pushed upward, since such a motion will push the plane downward. Rather, when the wing is flapping upward, the air should be pushed backward so that plane is pushed forward. The present invention uses the inventive flaps described herein, wherein flaps incorporated into the structure of the wings open to reduce the drag while pushing air backward without needing a complex mechanism to achieve the desired flight characteristics. Further, it has been noted that incorporating the flaps into the wing structure permits the plane to hover or stay in a single location without the airplane moving forward by tilting the plane cockpit upward.

The left side of FIG. 36 illustrates the flapping movement of the wings 1000 when viewing the plane body 1010 from the front. The beginning of the downward motion of the wings 1000 is identified by reference character 1000a, where the wings 1000 are oriented at 45 degrees relative to the ground. In this position, the flaps 1030 are closed due to air pressure (see the right side of FIG. 36, which shows a plan or top view of the plane at the same state). At position 1000b, the wings 1000 are nearly parallel to the ground, i.e., horizontal, and the flaps 1030 remain fully closed (see the right side of FIG. 36, which shows a plan or top view of the plane at the same state). At position 1000c, the wings 1000 have nearly completed their downward motion and the flaps 1030 (see the right side of FIG. 36, which shows a plan or top view of the plane at the same state).

At position 1000d, the wings 1000 initiate their upward motion, which is where the flaps 1030 are partially opened and pushes air backward (see the right side of FIG. 36, which shows a plan or top view of the plane at the same state). Because the flaps 1030 are extending downward and the wings 1000 are mowing upward, air pressure from above the wings 1000 and gravitational forces force flaps 1000 to be open. At positions 100e and 1000f, it should be noted the flaps 1030 remain open as the wing 1000 reaches heir uppermost position. Because the flaps 1030 are relatively small and light weight, the opening and closing of the flaps 1030 is fast and reduces the complexity of the control mechanism needed to control the system appropriately. The flaps 1030 are attached to the wing 1000 so that the rotational axis of each flap 1030 is toward the front portion of the wing 1000 so that when the wings 1000 are moving upward, the flaps 1030 open and air is forced toward the rear of the plane over the trailing edges of the flaps 1030.

While a particular embodiment of a flap may be described above with regards to a particular frame or assembly structure, it is within the scope, spirit and intent of the above described invention for any of the flaps to be interchangeably used with any of the above described frames or structures.

Although the present invention has been described with reference to a number of preferred embodiments, it is to be understood that the invention is not limited to the details thereof. A number of possible modifications and substitutions will occur to those of ordinary skill in the art, and all such modifications and substitutions are intended to fall with the scope of the invention.

What is claimed is:

1. A check valve turbine assembly, comprising:
an assembly base;
a vertical member rotatable relative to the base about an axis of rotation; and
a sail assembly attached to the vertical member, wherein the sail assembly comprises a frame having parallel horizontal airfoil members and parallel vertical airfoil members, a sub frame connected to the horizontal and vertical airfoil members, and a plurality of flaps rotatably attached to the sub frame, wherein
the flaps are configured to move between a closed position and an open position relative to the sub frame.

2. The check valve turbine assembly according to claim 1, wherein the sub frame comprises horizontal and vertical sub frame members.

3. The check valve turbine assembly according to claim 2, wherein the flaps rotate about an axis of the vertical sub frame members.

4. The check valve turbine assembly according to claim 2, wherein the flaps rotate about an axis of the horizontal sub frame members.

5. The check valve turbine assembly according to claim 1, wherein at least one flap of the plurality of flaps further comprises a primary flap member and a secondary flap member.

6. The check valve turbine assembly according to claim 5, wherein the primary flap member and the secondary flap member are configured to rotate about a common axis, and the secondary flap member swings through a plane defined by the primary flap member.

7. The check valve turbine assembly according to claim 6, further comprising a magnetic strip and a metal strip, wherein the magnetic strip is attached to one of the primary flap member and the secondary flap member and the metal strip is attached to the other one of the primary flap member and the secondary flap member so that a magnetic attraction of the metal strip to the magnetic strip ensures the secondary flap member is coplanar with the primary flap member when the flap is subjected to a force below a predetermined level.

8. The check valve turbine assembly according to claim 5, wherein the primary flap member has a first axis of rotation and the secondary flap member has a second axis of rotation different than the first axis of rotation, and the secondary flap member swings through a plane defined by the primary flap member.

9. The check valve turbine assembly according to claim 8, further comprising a strip spring joined to the primary flap member, wherein the strip spring pushes on the secondary flap member to be coplanar with the primary flap member until a predetermined force applied against the flap forces the secondary flap into an open position.

10. The check valve turbine assembly according to claim 5, further comprising a weighting device attached to the secondary flap member.

11. The check valve turbine assembly according to claim 5, wherein the at least one flap further comprises a flexible material, wherein the flexible material is configured to bend when a predetermined force is applied against the flap.

12. The check valve turbine assembly according to claim 1, wherein the sail assembly further comprises a plurality of sub sail assemblies, each sub sail assembly comprising
a sub sail frame rotatably attached to the frame of the sail assembly;
a sub sail sub frame attached to the sub sail frame; and
wherein the plurality of flaps are attached to the sub sail sub frame.

13. The check valve turbine assembly according to claim 12, further comprising a locking mechanism to hold the sub sail assembly in a closed position.

14. The check valve turbine assembly according to claim 12, further comprising a braking mechanism to prevent rotation of the turbine assembly from a stopped position.

15. The check valve turbine assembly according to claim 12, further comprising a rotation bearing and rotation motor, wherein the rotation motor rotates the sub sail assemblies through the rotation bearing on a centrally located axis so the sub sail assemblies may define a parallel plane relative to a direction of applied force.

16. The check valve turbine assembly according to claim 13, further comprising an electronic mechanism to unlock the locking mechanism to allow the sub sail assemblies to swing through a plane defined by the frame of the sail assembly.

17. The check valve turbine assembly according to claim 1, wherein at least one of the horizontal sub frame member and the vertical sub frame member comprises an extruded channel for mounting the flap therein.

18. The check valve turbine assembly according to claim 17, wherein the extruded channel is configured to restrict rotation of the flap.

19. The check valve turbine assembly according to claim 17, further comprising a snap ring spanning the extruded channel.

20. The check valve turbine assembly according to claim 1, wherein at least one flap of the plurality of flaps comprises a rigid flap frame that surrounds and supports an expandable membrane member.

21. The check valve turbine assembly according to claim 1, wherein at least one flap of the plurality of flaps comprises a square scoop portion, the scoop portion comprising a curved back surface.

22. The check valve turbine assembly according to claim 1, wherein at least one flap of the plurality of flaps comprises a pair of flexible panels, each flexible panel configured to open by swinging away from the other panel and close by swinging toward the other panel.

23. The check valve turbine assembly according to claim 22, wherein at least one of the horizontal sub frame member and the vertical sub frame member comprises an extruded channel having a detent surface, wherein the flap is configured to fit into the extruded channels and the detent surface restricts rotation of the flap.

24. The check valve turbine assembly according to claim 23, further comprising at least one support strip attached to the panels, wherein the sub frame further comprises fin extensions that connect to an interior end of the at least one support strip.

25. The check valve turbine assembly according to claim 1, wherein the horizontal members of the frame are curved.

26. The check valve turbine assembly according to claim 25, wherein the frame and sub frame comprise a rigid material.

27. The check valve turbine assembly according to claim 26, wherein the flaps comprise a flexible material.

28. The check valve turbine assembly according to claim 27, wherein the flaps are connected to the subframe by an adhesive.

29. A turbine system, comprising:
an assembly base;
a vertical member rotatable relative to the base about an axis of rotation; and
at least one flexible sail assembly attached to the vertical member, wherein the sail assembly comprises a lower beam attached to the vertical member, a flexible sub frame connected to the lower beam and the vertical member, and a plurality of flexible flaps attached to the flexible sub frame.

30. A turbine system, comprising:
a floating platform;
a generator;
a gearbox connected to the generator; and
a check valve turbine assembly that drives the gearbox, the check valve turbine assembly comprising:
a vertical member rotatable relative an axis of rotation and connected to the gearbox; and
at least one sail assembly attached to the vertical member, wherein the sail assembly comprises a frame and a plurality of flaps connected to the frame, wherein the flaps are configured to move between a closed position and an open position relative to the frame, and wherein the floating platform supports the generator.

31. A check valve turbine assembly, comprising:
an assembly base;
a vertical member rotatable relative to the base about an axis of rotation;
at least one sail assembly attached to the vertical member, wherein the sail assembly comprises a frame and a flap connected to the frame;
a planetary gear mechanism drivably connected to the vertical member;
a vertical shaft connected to the planetary gear mechanism
a fluid channel comprising an inlet side and a pump side; and
pump blades connected to the vertical shaft, wherein
the vertical shaft is coaxial with the vertical member and the pump side of the fluid channel has a reduced cross section from the inlet side of the fluid channel.

32. A check valve assembly, comprising:
a longitudinal center section; and
a wing section joined to the longitudinal center section, wherein
the wing section comprises multiple fenestrations and flaps, wherein the flaps are configured to cover the fenestrations during a downward motion of the wing section, and the flaps are configured to partially open during an upward motion of the wing section to direct air toward the rear of the longitudinal center section.
